(19) United States
(12) Patent Application Publication
(10) Pub. No.: US 2009/0109483 A1
(43) Pub. Date: Apr. 30, 2009

(54) Image processing apparatus and application execution method

(75) Inventor: Takafumi Shimmoto, Kanagawa (JP)

Correspondence Address: HARNESS, DICKEY & PIERCE, P.L.C., P.O. BOX 8910, RESTON, VA, 20195, US

(73) Assignee: RICOH COMPANY, LTD.

(21) Appl. No.: 12/285,396

(22) Filed: Oct. 3, 2008

(30) Foreign Application Priority Data
Oct. 30, 2007 (JP) 2007-282453

(51) Int. Cl. G06F 15/00

(52) U.S. Cl. 358/1.15

(57) ABSTRACT

A disclosed image processing apparatus includes one or more input units each configured to input data subject to image processing; one or more output units each configured to output a result of the image processing; a first filter configured to control input from a corresponding one of the input units; and a second filter configured to control output to a corresponding one of the output units. An application is constructed by connecting the first and second filters. The image processing apparatus further includes a third filter disposed between the first and second filters and configured to convert an image data type. During job execution, the third filter inquires about image data types processable by the first and second filters, and performs, when the types are different, conversion from the image data type processable by the first filter into the image data type processable by the second filter.

### BACKGROUND OF THE INVENTION

1. Field of the Invention

The present invention relates to an image processing apparatus and an application execution method, in particular to an image processing apparatus and an application execution method having multiple types of input units for inputting data subject to image processing and multiple types of output units for outputting results of the image processing.

2. Description of the Related Art

Although image processing apparatuses in recent years—such as printers, photocopy machines, scanner devices, facsimile apparatuses, and multi function peripherals (MFPs) which are single unit devices serving multiple functions of the aforementioned apparatuses—remain the problem of limited memory capacity and the like, they have been developed to be equipped with a CPU as in the case of general-purpose computers and each of their functions is implemented by application control.

For example, an image processing apparatus disclosed in Patent Document 1 includes functions commonly used by multiple applications in its platform, and applications can be implemented using an API (Application Program Interface) of the platform. According to such an image processing apparatus, since commonly used functions are included in the platform, it is possible to prevent implementation of functions from overlapping in multiple applications and improve the efficiency of developing entire applications.

Patent Document 1: Japanese Patent Publication No. 3679349

However, regarding a platform equipped with a commonly used API, if a function provided by the platform or the interface granularity is not appropriately designed, it is sometimes the case that the efficiency of developing applications is not improved as expected.

For instance, if the granularity is too fine, a lot of API functions need to be called even for an application providing a simple service, which results in complex source code.

On the other hand, if the granularity is too coarse, in the case where an application providing a service by changing a part of a function provided by an interface is desired to be implemented, the platform needs to be internally modified, which is likely to increase the number of development processes. Particularly, in the case where modules on the platform are highly dependent on one another, it may be necessary not only to add new functions to the platform, but also to modify existing parts of the platform, thus making the issue more complex.

In addition, in the case where it is desired to implement an application configured by modifying a part of service (for example, an image input process) provided by an existing application, it is not possible to call the existing application for parts other than the aforementioned part of service. In this case, a new application configured by writing new source code needs to be implemented.

### SUMMARY OF THE INVENTION

In view of the above-mentioned conventional problems, the present invention aims at providing an image processing apparatus and an application execution method that simplify functionality customization, functionality extension or the like.

The present invention also aims at providing an image processing apparatus and an application execution method that, in the case where the type of image data processable by an image-data input component is different from that processable by an image-data output component, perform appropriate processing without making the user aware of the difference in the image data types.

The above-mentioned problems can be solved according to one embodiment of the present invention by providing an image processing apparatus that includes one or more input units each configured to input data subject to image processing; one or more output units each configured to output a result of the image processing; a first filter configured to control input from a corresponding one of the input units in a manner according to the corresponding input unit; and a second filter configured to control output to a corresponding one of the output units in a manner according to the corresponding output unit. An application is constructed by connecting the first and the second filters. The image processing apparatus further includes a third filter disposed between the first and the second filters and configured to convert an image data type. During job execution, the third filter makes an inquiry about image data types processable by the first and the second filters, and performs, when the image data types are different from each other, conversion from the image data type processable by the first filter into the image data type processable by the second filter.

The above-mentioned problems can be also solved according to another embodiment of the present invention by providing an application execution method used in an image processing apparatus including one or more input units each configured to input data subject to image processing; one or more output units each configured to output a result of the image processing; a first filter configured to control input from a corresponding one of the input units in a manner according to the corresponding input unit; and a second filter configured to control output to a corresponding one of the output units in a manner according to the corresponding output unit. An application is constructed by connecting the first and the second filters. The application execution method comprising the steps of inserting a third filter between the first and the second filters, the third filter being configured to convert an image data type; and during job execution, causing the third filter to make an inquiry about image data types processable by the first and the second filters, and perform, when the image data types are different from each other, conversion from the image data type processable by the first filter into the image data type processable by the second filter.

### BRIEF DESCRIPTION OF THE DRAWINGS

FIG. 1 shows an example of a software configuration of an MFP according to a first embodiment;

FIG. 2 is a diagram for illustrating a concept of a pipes and filters architecture;

FIG. 3 shows an example of a hardware configuration of the MFP;

FIG. 4 illustrates components of an activity;

FIG. 5 illustrates components of a filter;

FIG. 6 shows examples of filter combinations for implementing individual functions of the MFP;

FIG. 7 is a first half of a flowchart illustrating an operating procedure of the MFP for implementing one function;

FIG. 8 is a second half of the flowchart illustrating the operating procedure of the MFP for implementing one function;

FIG. 9 shows an example of an operation screen which allows a user to use activities;

FIG. 10 conceptually shows request content issued from a user interface layer to a control layer;

FIG. 11 shows an example of a correspondence table between filters and pipes;

FIG. 12 conceptually shows information generated by the control layer;

FIG. 13 illustrates an order of data transmission between filters via a pipe;

FIG. 14 shows an example of a software configuration of the MFP according to a second embodiment;

FIG. 15 shows an example of a preference and the like included in each component;

FIG. 16 is a flowchart showing an overview of processing according to the second embodiment;

FIG. 17 shows flowcharts illustrating examples of a preference modification process by an activity;

FIG. 18 illustrates a pattern [1];

FIG. 19 is a sequence diagram showing an example of a preference configuration process;

FIG. 20 shows an example of data included in each component;

FIG. 21 is a sequence diagram showing an example of the preference modification process;

FIG. 22 shows another example of data included in each component;

FIG. 23 shows yet another example of data included in each component;

FIG. 24 is a sequence diagram showing an example of an execution process;

FIG. 25 shows yet another example of data included in each component;

FIG. 26 illustrates a pattern [2];

FIG. 27 illustrates a pattern [3];

FIG. 28 illustrates a pattern [4]; and

FIG. 29 illustrates a pattern [5].

### DESCRIPTION OF THE PREFERRED EMBODIMENTS

Next are described preferred embodiments of the present invention.

### First Embodiment

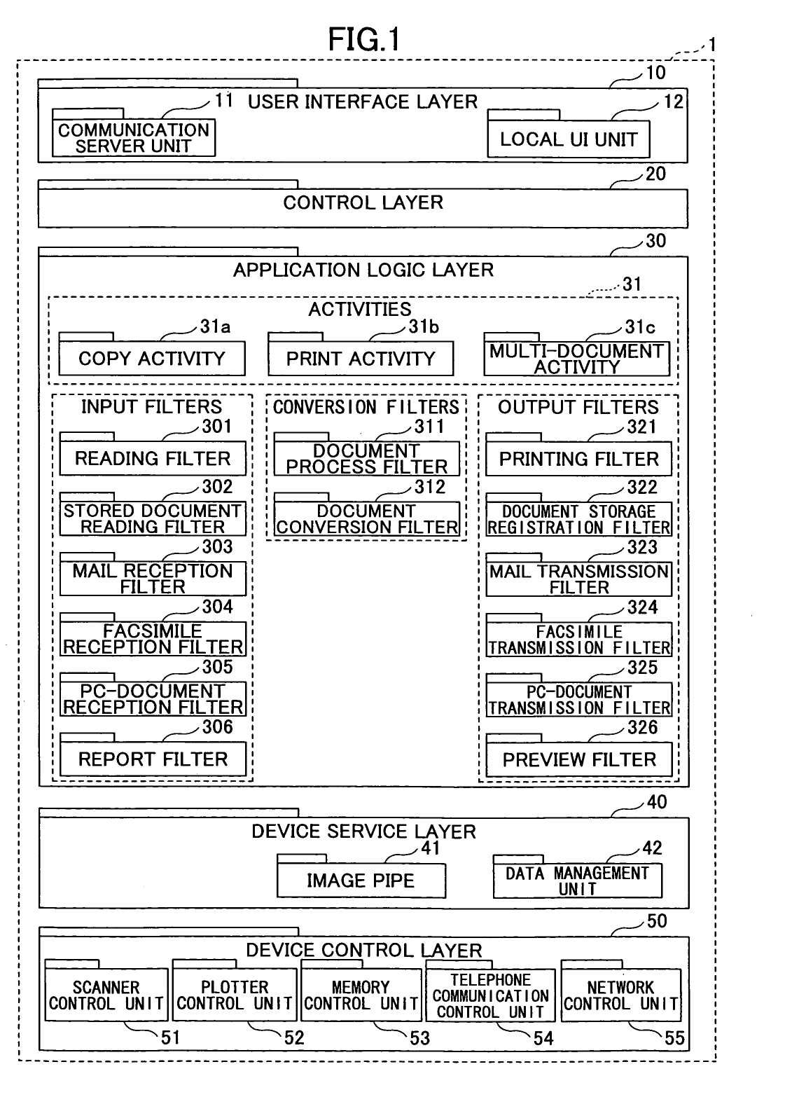

FIG. 1 shows an example of a software configuration of an MFP (multi function peripheral) according to a first embodiment. The term “MFP” herein referred to means a single-unit image processing apparatus providing multiple functions of a printer, photocopy machine, scanner device, facsimile apparatus and/or the like.

As shown in FIG. 1, software of an MFP 1 comprises a user interface layer 10, a control layer 20, an application logic layer 30, a device service layer 40, a device control layer 50 and the like. Note that the layers 10 through 50 in FIG. 1 are shown in a hierarchy, which is based on their call relationships. That is, basically, an upper layer calls a lower layer in FIG. 1.

The user interface layer 10, where a function of receiving an execution request for a function (for example, copying, printing, scanning or facsimile transmission) is implemented, includes a communication server unit 11 and a local UI unit 12, for example. The communication server unit 11 receives a request from, for example, a client PC (Personal Computer) (not shown) via a network. The local UI unit 12 receives a request input via an operation panel (not shown), for example. A request received at the user interface layer 10 is communicated to the control layer 20.

The control layer 20 is where a function of controlling a process for implementing a requested function is implemented. Specifically, the control layer 20 connects filters in the application logic layer 30 in accordance with a requested function, and controls execution of the function based on the connected filters. Note that the term “function of the MFP 1” in the present embodiment is synonymous with one set of service (from a request input to acquisition of a final output) provided by the MFP 1 to the user, and is synonymous, in the software sense, with an application which provides one set of service.

The application logic layer 30 is where components, each of which implements a part of a function provided by the MFP 1, are implemented. That is, one function is implemented by combining components in the application logic layer 30. The components are hereinafter referred to as “filters.” This is because the software architecture of the MFP 1 is based on the concept of “pipes and filters architecture.”

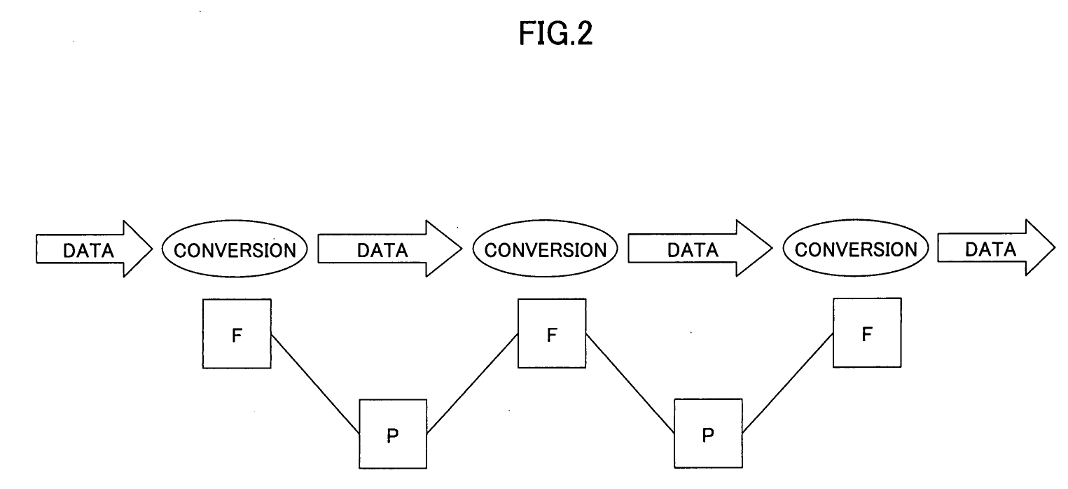

FIG. 2 is a diagram for illustrating the concept of the pipes and filters architecture. In FIG. 2, the letter “F” indicates a filter and the letter “P” indicates a pipe. As shown in the FIG. 2, filters are connected by pipes. Each filter performs a conversion on input data, and outputs the result of the conversion. Each pipe communicates the output data of a filter to the next filter.

That is, in the MFP 1 according to the present embodiment, each function is taken as a succession of “conversions” on a document (data). Each function of the MFP 1 can be generalized as being configured of inputting, processing and outputting of a document. Here, “inputting”, “processing” and “outputting” are taken as “conversions,” and a software component that implements one “conversion” is configured as a filter. A filter that implements inputting is referred to as “input filter”; a filter that implements processing, “conversion filter”; and a filter that implements outputting, “output filter”. Each filter is independent, and basically, there is no dependency (call relationship) between filters. Accordingly, it is possible to perform addition (installation) and deletion (uninstallation) on a filter-by-filter basis.

Referring back to FIG. 1, the application logic layer 30 includes, as input filters, a reading filter 301, a stored document reading filter 302, a mail reception filter 303, a facsimile reception filter 304, a PC-document reception filter 305, a report filter 306 and the like.

The reading filter 301 controls reading of image data by a scanner and outputs the read image data. The stored document reading filter 302 reads document data (image data) stored in memory storage of the MFP 1 and outputs the read data. The mail reception filter 303 receives e-mail and outputs data contained in the e-mail. The facsimile reception filter 304 controls facsimile reception and outputs received data. The PC-document reception filter 305 receives print data from a client PC (not shown) and outputs the received print data. The report filter 306 outputs setting information, history information and the like of the MFP 1 as, for example, tabular data.

The application logic layer 30 further includes a document process filter 311, a document conversion filter 312 and the like as conversion filters. The document process filter 311 performs predetermined image conversion (such as combining, enlargement or reduction) on input data and outputs the converted data. The document conversion filter 312 performs rendering, that is, converts input PostScript data into bitmap data and outputs the bitmap data.

The application logic layer 30 further includes, as output filters, a printing filter 321, a document storage registration filter 322, a mail transmission filter 323, a facsimile transmission filter 324, a PC-document transmission filter 325, a preview filter 326 and the like.

The printing filter 321 causes a plotter to output (print) input data. The document storage registration filter 322 stores input data in a hard disk unit of the MFP 1. The mail transmission filter 323 transmits input data as an attachment to e-mail. The facsimile transmission filter 324 transmits input data by facsimile. The PC-document transmission filter 325 transmits input data to a client PC. The preview filter 326 causes the operation panel of the MFP 1 to preview input data.

Also, the application logic layer 30 includes activities 31, such as a copy activity 31a, a print activity 31b and multi-document activity 31c. Here, an “activity” is software that implements one “function” (one set of service, or application, provided by the MFP 1 to the user) using a predefined combination of filters.

That is, a “function of the MFP 1” can be built up by allowing the user to select individual filters; however, for frequently used functions like copy, it is troublesome for the user to select filters each time and direct an execution. Given this factor, combinations of filters are predefined as activities 31, and if the user selects an activity 31 as an execution target, the selected activity 31 automatically implements a combination of filters predefined for the activity 31. Herewith, it is possible to eliminate cumbersome operations and provide a sense of operability similar to that of a conventional user interface allowing selection of an execution target on an application-by-application basis.

In FIG. 1, the copy activity 31a is a combination of the reading filter 301, document process filter 311 and printing filter 321, and implements a copy function (copy application).

The print activity 31b is a combination of the PC-document reception filter 305, document conversion filter 312 and printing filter 321, and implements a print function (printing application).

The multi-document activity 31c allows a free combination of input, conversion and output filters.

Each activity 31 is independent, and basically, there is no dependency (call relationship) between activities 31. Accordingly, it is possible to perform addition (installation) or deletion (uninstallation) on an activity-by-activity basis. Therefore, activities 31 other than those shown in FIG. 1 can be created by combining various filters and installed if necessary.

On the other hand, the device service layer 40, where lower-level functions used in common by the filters of the application logic layer 30 are implemented, includes an image pipe 41 and a data management unit 42, for example. The image pipe 41 implements the above-mentioned pipe function—that is, communicating output data from a filter to the next filter. The data management unit 42 represents various databases such as a database with which user information is registered and a database in which documents, image data or the like are stored.

The device control layer 50, where program module groups—referred to as drivers—for controlling devices (hardware) are implemented, includes a scanner control unit 51, a plotter control unit 52, a memory control unit 53, a telephone communication control unit 54 and a network control unit 55, for example. Each of these control units controls a device indicated by the name of the control unit.

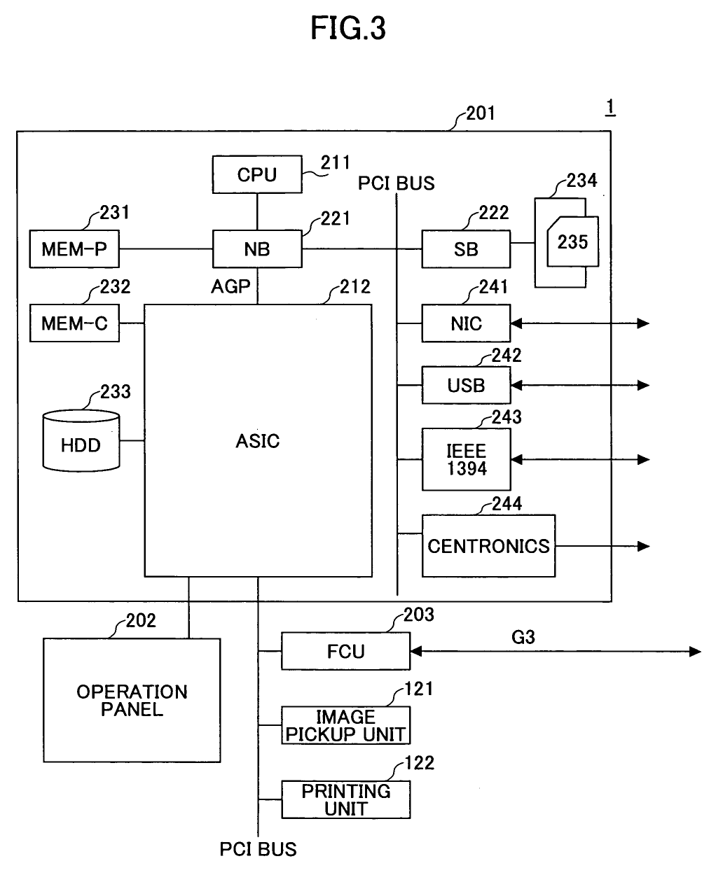

FIG. 3 shows an example of a hardware configuration of the MFP 1. The hardware of the MFP 1 includes a controller 201, an operation panel 202, a facsimile control unit (FCU) 203, an image pickup unit 121 and a printing unit 122.

The controller 201 comprises a CPU 211, an ASIC 212, an NB 221, an SB 222, an MEM-P 231, an MEM-C 232, an HDD (Hard Disk Drive) 233, a memory card slot 234, an NIC (Network Interface Controller) 241, a USB device 242, an IEEE 1394 device 243, and a Centronics device 244.

The CPU 211 is an IC (Integrated Circuit) for various information processes. The ASIC 212 is an IC for various image processes. The NB 221 is a north bridge of the controller 201. The SB 222 is a south bridge of the controller 201. The MEM-P 231 is a system memory of the MFP 1. The MEM-C 232 is a local memory of the MFP 1. The HDD 233 is storage of the MFP 1. The memory card slot 234 is a slot in which a memory card 235 is set. The NIC 241 is a controller for network communication using a MAC address. The USB device 242 serves as a USB connecting terminal. The IEEE 1394 device 243 serves as an IEEE 1394 connecting terminal. The Centronics device 244 serves as a connecting terminal in conformity to the Centronics standard. The operation panel 202 is a hardware component (operating unit) allowing the operator to perform input into the MFP 1 and is also a hardware component (display unit) allowing the operator to obtain output from the MFP 1.

Note that the software shown in FIG. 1 is stored in the MEM-C 232, for example, and the function of each software component is implemented by the MFP 1 when the CPU 211 processes the software component.

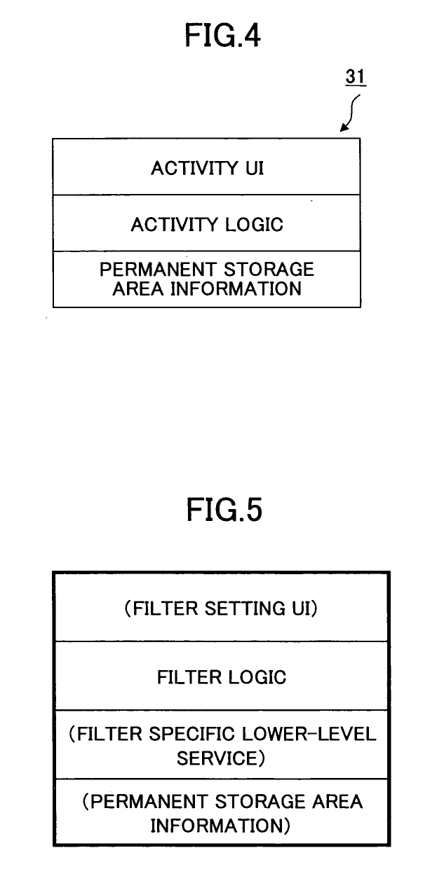

The following describes further details of the “activity” and “filter.” FIG. 4 illustrates components of an activity. As shown in FIG. 4, the activity 31 comprises an activity UI, activity logic and permanent storage area information and the like.

The activity UI is information or a program for causing a screen related to the activity 31 (e.g. a setting screen on which execution conditions and the like of the activity 31 are to be configured) to be displayed on the operation panel 202, for instance.

The activity logic is a program on which process contents of the activity 31 are implemented. Basically, logic regarding the combination of the filters (e.g. an order for executing the filters, settings across multiple filters, changes in connection of filters, and error processing) is implemented in the activity logic.

The permanent storage area information corresponds to a schema definition of data—such as setting information for the activity 31 (e.g. default values for the execution conditions)—necessary to be stored in nonvolatile memory. The schema definition is registered to the data management unit 42 when the activity 31 is installed.

FIG. 5 illustrates components of a filter. As shown in FIG. 5, each filter comprises a filter setting UI, filter logic, filter specific lower-level service, permanent storage area information and the like. Of them, the filter setting UI, filter specific lower-level service and permanent storage area information are not always included in every filter.

The filter setting UI is a program for causing a screen, on which execution conditions of the filter are to be configured, to be displayed on the operation panel 202, for instance. For example, in the case of the reading filter 301, the filter setting UI causes a screen allowing setting of resolution, concentration, an image type and the like to be displayed. Note that in view of the display of the operation panel 202 being possibly implemented based on HTML data or scripts, the filter setting UI may be HTML data or script data.

The filter logic is a program on which logic for executing a function of the filter is implemented. That is, the function of the filter is executed according to execution conditions configured via the filter setting UI, using for instance the device service layer 40, the device control layer 50 or the filter specific lower-level service, which is a component of the filter. For example, in the case of the reading filter 301, the filter logic corresponds to logic for controlling reading of an original by a scanner.

The filter specific lower-level service is a lower-level function (library) necessary to implement the filter logic. That is, the function corresponds to the function of the device service layer 40 or the device control layer 50. In the case there is a function not used by other filters, the function may be implemented as a part of the filter, and this part of the filter is the filter specific lower-level service. For example, in the case of the reading filter 301, a function of controlling the scanner is the filter specific lower-level service; however, in the present embodiment, it is implemented as the scanner control unit 51 in the device control layer 50. Accordingly, the filter specific lower-level service is not always necessary to be implemented in the reading filter 301.

The permanent storage area information corresponds to a schema definition of data—such as setting information for the filter (e.g. default values for the execution conditions)—necessary to be stored in nonvolatile memory. The schema definition is registered to the data management unit 42 when the filter is installed.

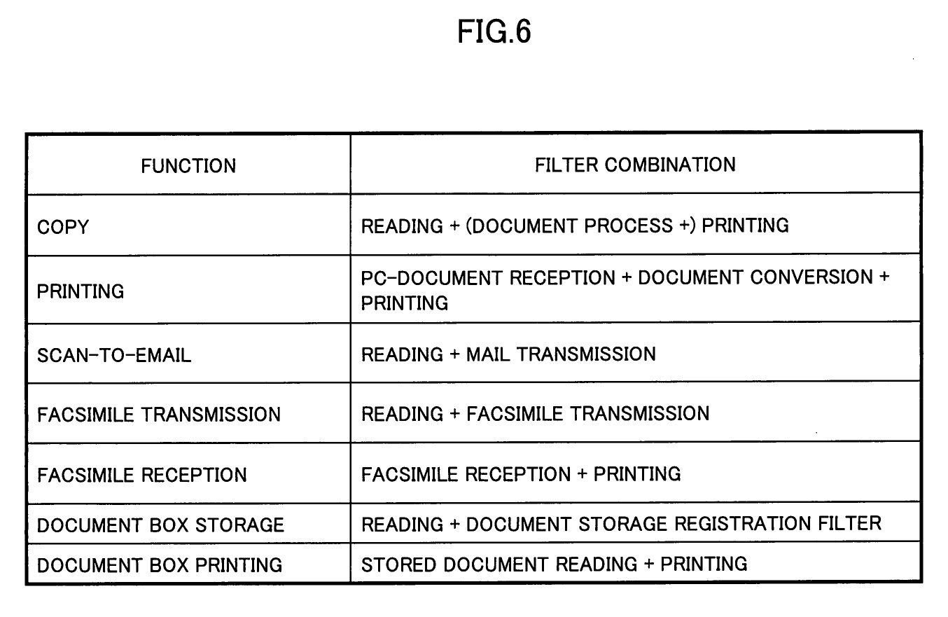

FIG. 6 shows examples of filter combinations for executing individual functions of the MFP 1. For example, a copy function is executed by connecting the reading filter 301 and printing filter 321. The combination allows image data to be read from an original by the reading filter 301 and the read image data is printed by the printing filter 321. Note that in the case where a process such as aggregation, enlargement or reduction is requested, the document process filter 311 for executing the process is inserted between the two filters.

A printing function (a printing function requested by the client PC) is implemented by connecting the PC-document reception filter 305, document conversion filter 312 and printing filter 321. A scan-to-email function (a function of transferring scanned image data by email) is implemented by connecting the reading filter 301 and mail transmission filter 323. A facsimile transmission function is implemented by connecting the reading filter 301 and facsimile transmission filter 324. A facsimile reception function is implemented by connecting the facsimile reception filter 304 and printing filter 321. A document box storage function (a function of storing scanned image data in the MFP 1) is implemented by connecting the reading filter 301 and document storage registration filter 322. A document box printing function (a function of printing document data stored in the MFP 1) is implemented by connecting the stored document reading filter 302 and printing filter 321.

In FIG. 6, for example, the reading filter 301 is used in four functions (copy, scan-to-email, facsimile transmission and document box storage). Thus, each filter can be used in multiple functions, whereby it is possible to reduce the number of development processes for implementing each function. For instance, the copy function and the scanning function (document box storage) have similar user interfaces for allowing configuration of execution conditions. However, according to conventional technology, in the case where each function is implemented by an application, a user interface is implemented with respect to each application. On the other hand, according to the present embodiment, execution conditions are configured via the user interface of the reading filter 301 for either the copy function or the scanning function, thus promoting sharing of the user interface.

Next are considered cases of implementing new functions. First, a case of implementing Function #1—a function of printing print data transmitted from a client PC and described in a PLD (Page Description Language) which is not supported by the MFP 1 (hereinafter referred to as “unsupported PDL”)—is considered. In this case, the printing function of FIG. 6 can be used as a basic format. Note however that the printing function is premised that data output from the PC-document reception filter 305 is in PostScript format. This is because the document conversion filter 312 can handle, as its input data, only data conforming to the PostScript standard. However, in Function #1, data received and output by the PC-document reception filter 305 is described in an unsupported PDL. Therefore, if the data in the unsupported PDL is transferred to the document conversion filter 312, the document conversion filter 312 cannot properly process the data. In view of the problem, a conversion filter (hereinafter referred to as “unsupported PDL to PS conversion filter”) for converting data from the unsupported PDL format to PostScript format is newly implemented. Function #1 can be implemented by inserting the unsupported PDL to PS conversion filter between the PC-document reception filter 305 and the document conversion filter 312. That is to say, Function #1 is implemented by connecting the PC-document reception filter 305, unsupported PDL to PS conversion filter, document conversion filter 312 and printing filter 321.

Next, a case of realizing Function #2—a function of gathering information from websites and printing the gathered information—is considered. In this case, there is no filter for gathering information from websites. Therefore, it is necessary to at least newly implement an input filter (hereinafter referred to as “web information gathering filter”) for gathering information from websites. With Function #2, since printing needs to be performed at the end, it is appropriate to use the printing filter 321 as the output filter of the function. At this point, how to connect between the web information gathering filter and the printing filter 321 becomes an issue. That is, although input data of the printing filter 321 must be a rendered bitmap, implementing a rendering function in the web information gathering filter is not appropriate since it requires a great number of processing operations. In view of the problem, the use of the document conversion filter 312 that implements the rendering function is considered. Note however that input data of the document conversion filter 312 must be in PostScript format. Accordingly, if the web information gathering filter is implemented in such a manner to output the gathered information in PostScript format, the web information gathering filter can be connected to the document conversion filter 312. Thus, by implementing the web information gathering filter, Function #2 is implemented by connecting the web information gathering filter, the document conversion filter 312 and the printing filter 321.

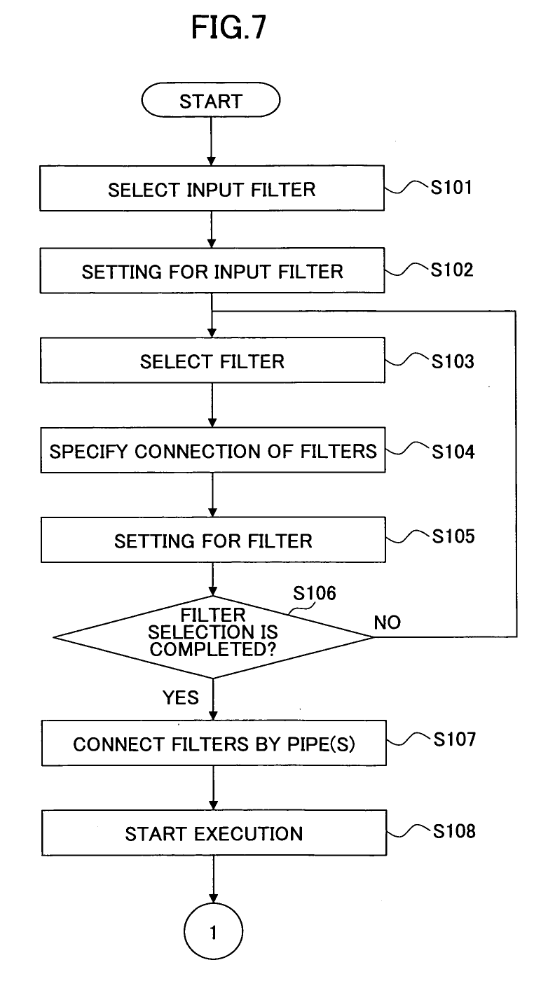

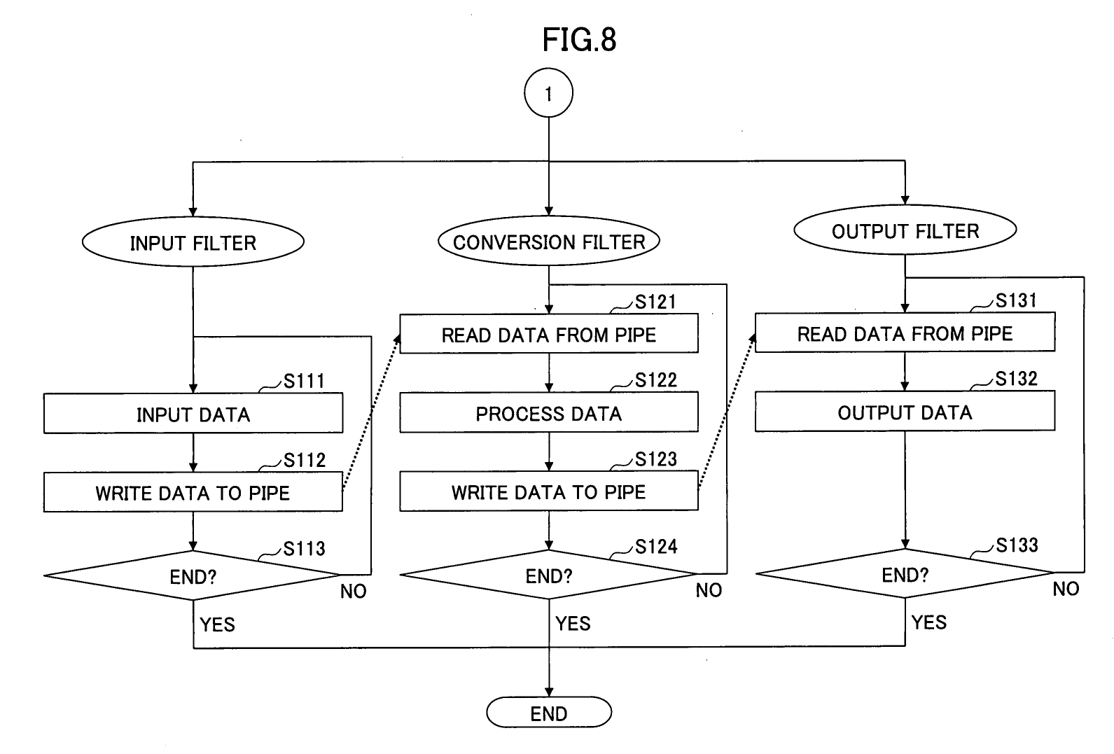

The following describes an operating procedure of the MFP 1 according to the present embodiment. FIGS. 7 and 8 show a flowchart illustrating an operating procedure of the MFP 1 for implementing one function.

First, when the user selects an activity, an input filter specified by the selected activity is selected (Step S101), and execution conditions of the selected input filter are then configured (Step S102). Similarly, a selection is made for a conversion filter or an output filter of the selected activity (Step S103), then a filter connection of the selected filter is specified (Step S104), and execution conditions of the selected filter are configured (Step S105).

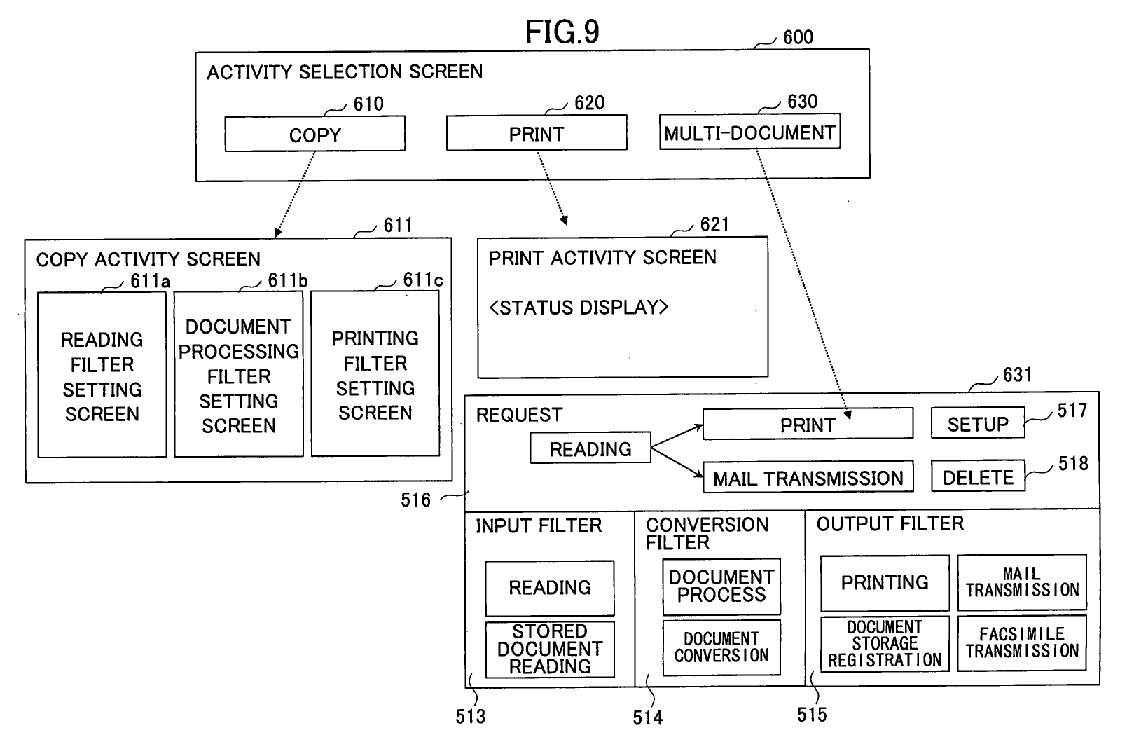

The above-mentioned operation is performed under the control of the local UI unit 12 via, for example, an operation panel (the operation panel 202 of FIG. 3) shown in FIG. 9. The operation panel 202 includes a touch panel and a start button. The touch panel is a hardware component (touch operating unit) for allowing input by touch operation and is also a hardware component (image display unit) for presenting output on a screen display. The start button is a hardware component for directing to start the execution of a requested function.

FIG. 9 shows an example of an operation screen which allows the user to use activities. In FIG. 9, an activity selection screen 600 allows the user to select an activity as an execution target, and is displayed on the touch panel of the operation panel 202. On the activity selection screen 600, buttons corresponding to the activities 31 installed on the MFP 1 are displayed. FIG. 9 shows a copy button 610 corresponding to the copy activity 31a, a print button 620 corresponding to the print activity 31b, and a multi-document button 630 corresponding to the multi-document activity 31c.

Note that list information of the installed activities 31 is stored in memory storage and managed for example by the control layer 20. Therefore, the local UI unit 12 obtains the list information of the activities 31 by making an inquiry to the control layer 20, and displays buttons on the activity selection screen 600 based on the list information.

If the copy button 610 is selected (touched) on the activity selection screen 600, the local UI unit 12 obtains screen information of the copy activity 31a by calling the activity UI of the copy activity 31a, and causes the touch panel to display a copy activity screen 611 based on the screen information. The copy activity screen 611 is for allowing the user to configure execution conditions of the copy activity 31a, and FIG. 9 shows an example in which setting screens (a reading filter setting screen 611a, a document process filter setting screen 611b and a printing filter setting screen 611c) of the filters making up the copy activity 31a are displayed. That is, execution conditions of the copy activity 31a are configured by setting the execution conditions of each component filter. Screen information of the setting screen of each component filter is obtained when the activity UI of the copy activity 31a calls the filter setting UI of each component filter in accordance with a call from the local UI unit 12, and is then included (merged) in the screen information of the copy activity 31a. Instead of simply displaying the setting screens of the component filters, a UI (including, for example, a button for “double-sided to double-sided”, a button for read setting (double sided), and a button for print setting (double sided)) for allowing the user to configure settings collectively for the component filters may be displayed on the copy activity screen 611.

If the print button 620 is selected, the local UI unit 12 obtains screen information of the print activity 31b by calling the activity UI of the print activity 31b, and causes the touch panel to display a print activity screen 621 based on the screen information. The print activity screen 621 is for displaying the status (e.g. “printing in progress”) of the print activity 31b. That is, the print activity 31b is started in accordance with reception of print data (i.e. not started by a user operation on the operation panel 202), and therefore a setting screen is basically not necessary for this activity.

If the multi-document button 630 is selected, the local UI unit 12 obtains screen information of the multi-document activity 31c by calling the activity UI of the multi-document activity 31c, and causes the touch panel to display a multi-document activity screen 631 based on the screen information.

On the multi-document activity screen 631, any filters can be combined by a user operation. The multi-document activity screen 631 comprises, for example, an input filter selecting section 513, a conversion filter selecting section 514, an output filter selecting section 515 and a request display section 516. The input filter selecting section 513 is for allowing the user to select an input filter, and buttons corresponding to input filters are displayed. If a button in the input filter selecting section 513 is selected, an input filter button corresponding to the selected button is displayed in the request display section 516. In the example of FIG. 9, buttons for the reading filter 301 and the stored document reading filter 302 are displayed in the input filter selecting section 513.

The conversion filter selecting section 514 is for allowing the user to select a conversion filter, and buttons corresponding to conversion filters are displayed. If a button in the conversion filter selecting section 514 is selected, a conversion filter button corresponding to the selected button is displayed in the request display section 516.

The output filter selecting section 515 is for allowing the user to select an output filter, and buttons corresponding to output filters are displayed. If a button in the output filter selecting section 515 is selected, an output filter button corresponding to the selected button is displayed in the request display section 516. In the example of FIG. 9, buttons for the printing filter 321, document storage registration filter 322, mail transmission filter 323 and facsimile transmission filter 324 are displayed in the output filter selecting section 515.

Note that the list information of the installed filters (input filters, conversion filters and output filters) is stored in memory storage and managed for example by the control layer 20. Therefore, the local UI unit 12 makes an inquiry to the control layer 20 to thereby obtain the list information of the filters for displaying the input filter selecting section 513, conversion filter selecting section 514 and output filter selecting section 515.

In the request display section 516, buttons for filters selected in the input filter selecting section 513, conversion filter selecting section 514 and output filter selecting section 515 are displayed, and the filter buttons (input, conversion and output) in the request display section 516 are connected by an arrow/arrows which indicate a data flow or pipes. By operating the arrows, it is possible to change the execution order of the filters. The user is able to understand the filters to be used and the data flow from the content displayed in the request display section 516. In the request display section 516, a setup button 517 and a delete button 518 are also provided. The setup button 517 is for causing, in the case when a filter button has been selected in the request display section 516, the setting screen of a corresponding filter to be displayed. That is, if the setup button 517 is pressed (touched), the setting screen of the selected filter is displayed in a touch panel 511 based on the filter setting UI of the selected filter. The delete button 518 is for cancelling, in the case when a filter button has been selected in the request display section 516, the use of a corresponding filter.

Note that, for one function, more than one filter can be selected for each of the input, conversion and output filters. For example, in the case of synthesizing a scanned image and an image stored in the MFP 1 and then printing the synthesized image and also transmitting it by fax, two input filters (the reading filter 301 and stored document reading filter 302) and two output filters (the printing filter 321 and facsimile transmission filter 324) are at least selected.

Referring back to FIG. 7, if the filter selection is completed (Step S106: YES) and the start button is pressed, request content is issued from the user interface layer 10 to the control layer 20.

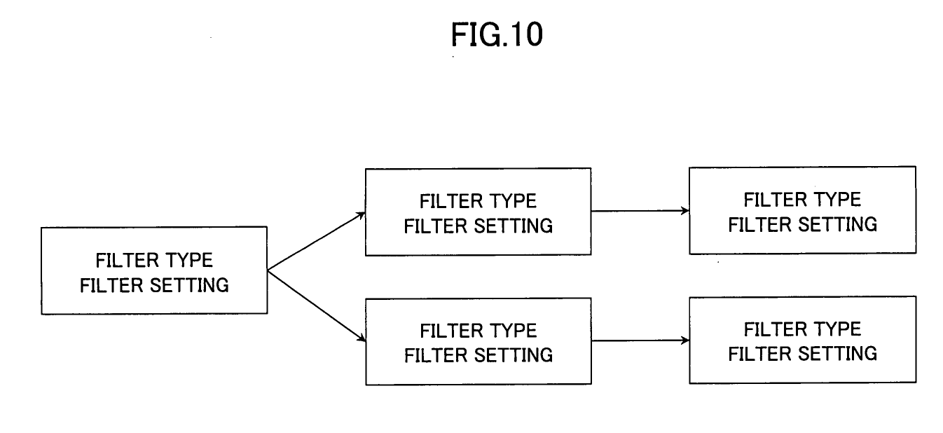

FIG. 10 conceptually shows the request content issued from the user interface layer 10 to the control layer 20. As shown in FIG. 10, the request content from the user interface layer 10 includes, for each filter selected in the user interface layer 10, a type of the filter and setting information of the filter as well as an execution order of the filters (arrows in FIG. 10 connecting the blocks indicate the execution order of the filters).

Referring back to FIG. 7, in response to receiving the above-mentioned request content, the control layer 20 connects the selected filters by pipes (Step S107). Each pipe entity is memory (including HDD (Hard Disk Drive); however, a type of memory used is different depending on filters on both sides of the pipe, and the corresponding relationships are preliminarily defined in, for example, the HDD of the MFP 1.

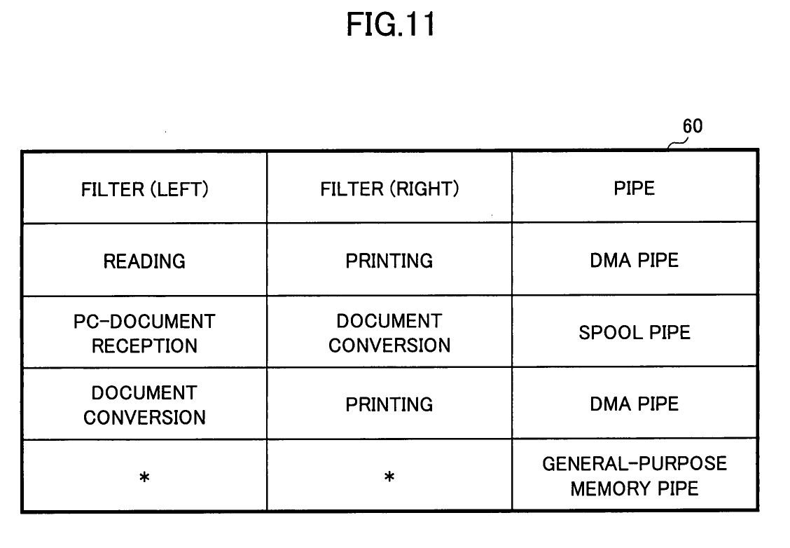

FIG. 11 shows an example of a correspondence table between filters and pipes. According to a correspondence table 60 of FIG. 11, for instance, the reading filter 301 and the printing filter 321, and the document conversion filter 312 and the printing filter 321 are connected by DMA (Direct Memory Access) pipes, and data is transferred at high speeds. The PC-document reception filter 305 and the document conversion filter 312 are connected by a spool pipe. The spool pipe uses a HDD, and data output from the filter on the left side is spooled (stored) in the HDD until the filter on the right side reads it. Filters other than the above-mentioned combinations are connected by general-purpose memory pipes. The general-purpose memory pipe is for transferring data using a RAM buffer of a limited size. The correspondence table 60 shown in FIG. 11 can be edited according to extension (addition) and deletion of filters and pipes. Note that the image pipe 41 of FIG. 1 is an abstract representation of modules that provide interfaces to the above-mentioned types of pipes.

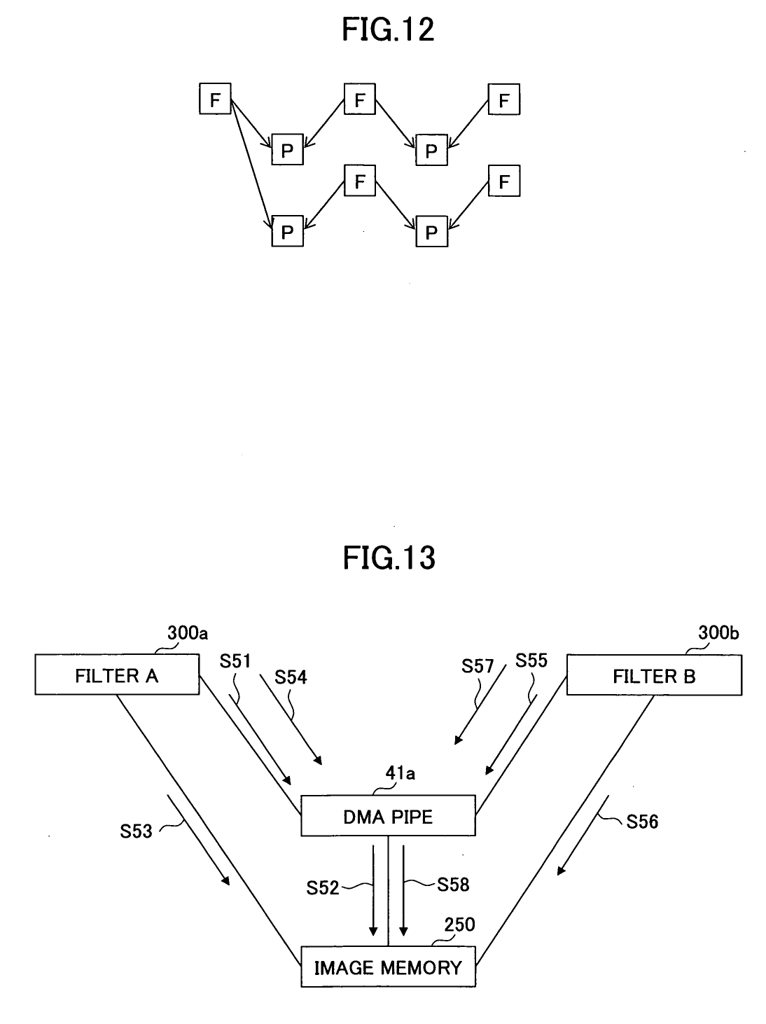

Accordingly, the control layer 20 connects filters by specific pipes based on the correspondence table 60 of FIG. 11. FIG. 12 conceptually shows information generated by the control layer 20. FIG. 12 depicts filters (F) connected by pipes (P).

Referring back to FIG. 7, the control layer 20 outputs an execution request to each filter in a parallel manner (Step S108). That is, calls are made not in the connection order of the filters but substantially simultaneously for all the filters. This is because the filters are synchronized by pipes. That is, after receiving the execution request from the control layer 20, each filter stands by until data is input to a pipe located on the input side of the filter. Note however that an input filter does not have a pipe on its input side, and therefore starts the process in response to the execution request.

Next, in FIG. 8, the input filter inputs data from an input device (Step S111) and outputs the data to a pipe connected on the output side (Step S112). Note that in the case where data is input in several batches (for example, in the case where two or more sheets of originals are scanned), the data input and the data output to the pipe are repeated. When the process is completed for all the input data (Step S113: YES), the process of the input filter ends.

The conversion filter starts its process when detecting data input to a pipe connected on its input side. First, the conversion filter reads data from the pipe (Step S121) and performs image processing on the data (Step S122). Then, the conversion filter outputs data, which is a result of the image processing, to a pipe located on the output side (Step S123). When the process is completed for all the input data in the pipe on the input side (Step S124: YES), the process of the conversion filter ends.

The output filter starts its process when detecting data input to a pipe connected on its input side. First, the output filter reads data from the pipe (Step S131), and then outputs the read data using an output device (Step S132). When the process is completed for all the input data in the pipe on the input side (Step S133: YES), the process of the output filter ends.

The following gives further details of the pipes. FIG. 13 illustrates an order of data transmission between filters via a pipe. In FIG. 13, a filter A 300a and a filter B 300b represent filters. A DMA pipe 41a is one example of the image pipe 41 of FIG. 11. Image memory 250 is physical (hardware) image memory provided in the MFP 1.

When data (image data) is transmitted from the filter A 300a to filter B 300b, the filter A 300a requests the DMA pipe 41a to secure a memory area for storing the image data (Step S51). The DMA pipe 41a secures the memory area and sends an address of the memory area to the filter A 300a (Step S52). The filter A 300a writes the image data at the sent address (the image memory 250) (Step S53), and notifies to the DMA pipe 41a the address at which the image data has been written (Step S54).

The filter B 300b repeatedly (periodically) makes an inquiry to the DMA pipe 41a about the address at which the image data has been written until the address is issued (Step S55). Alternatively, the filter B 300b may stand by until the address is notified. After the address is notified to the DMA pipe 41a from the filter A 300a, the filter B 300b obtains the address and detects the image data written in the image memory 250. Then, the filter B 300b reads the image data from the address of the image memory 250 (Step S56), and performs its process on the image data. After completion of the process, the filter B 300b requests the DMA pipe 41a to release the memory area of the address (Step S57). The DMA pipe 41a releases the memory area (Step S58).

Thus, data transmission between the filters is performed via image memory (shared memory), which eliminates the need to secure a memory area for each filter to store image data. As a result, it is possible to improve memory efficiency and process performance. In addition, since there is no call relationship between filters, independence of the filters can be ensured.

### Second Embodiment

A second embodiment of the present invention provides an image processing apparatus and an application execution method that, in the case where the type of image data processable by an image-data input component (input filter) is different from that processable by an image-data output component (output filter), perform appropriate processing without making the user aware of the difference in the image data types. The image data types include different color spaces, such as RGB and CMYK, and different file formats, such as TIFF, MMR, PDF and JPEG. Note that the second embodiment is based on the mechanism of the pipes and filters and basically has the same structure and operation as the first embodiment.

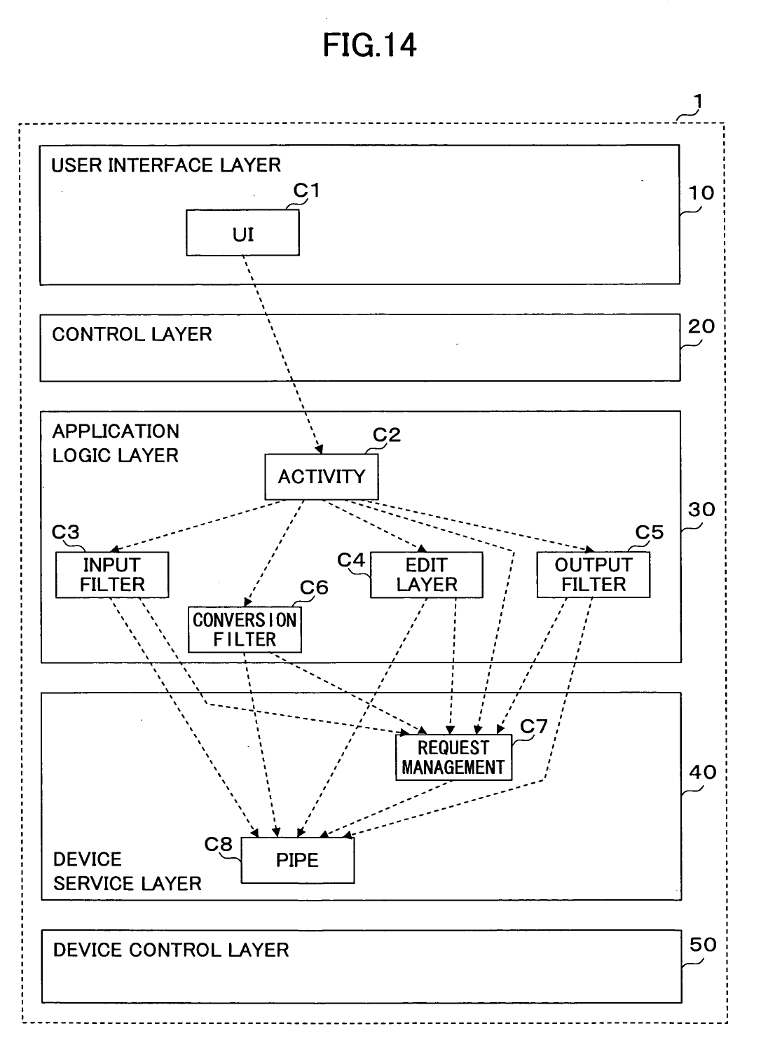

FIG. 14 shows an example of a software configuration of the MFP 1 according to the second embodiment.

In FIG. 14, a UI C1 which is a component for offering a user interface is provided in the user interface layer 10. In the application logic layer 30 are an activity C2 which is a component for offering predetermined functions, such as copy, facsimile transmission and mail transmission; an input filter C3 which is a component for offering an image data input function; an edit filter C4 which is a component for offering an image data editing function; an output filter C5 which is a component for offering an image data output function; and a conversion filter C6 which is a component for offering a function of converting an image data type. Note that the edit filter C4 is designed to include a conversion function equivalent to that of the conversion filter C6. In the present embodiment, the edit filter C4 is inserted at a point where the input filter C3 and the output filter C5 are directly connected to eliminate the difference in data formats, as described below. In the case where the edit filter C4 is preliminarily inserted between the input filter C3 and the output filter C5, the edit filter C4 is designed to also serve the conversion function rather than that the conversion filter C6 is inserted after the edit filter C4. Performing both edit process and conversion process at one time improves speed performance, which is the reason why the edit filter C4 is also equipped with the conversion function.

In the device service layer 40 are request management C7 which is a component for offering a function of processing a request sent from each component of the application logic layer 30; and a pipe C8 which is a component for offering a function of acting as an intermediary for transferring image data between filters.

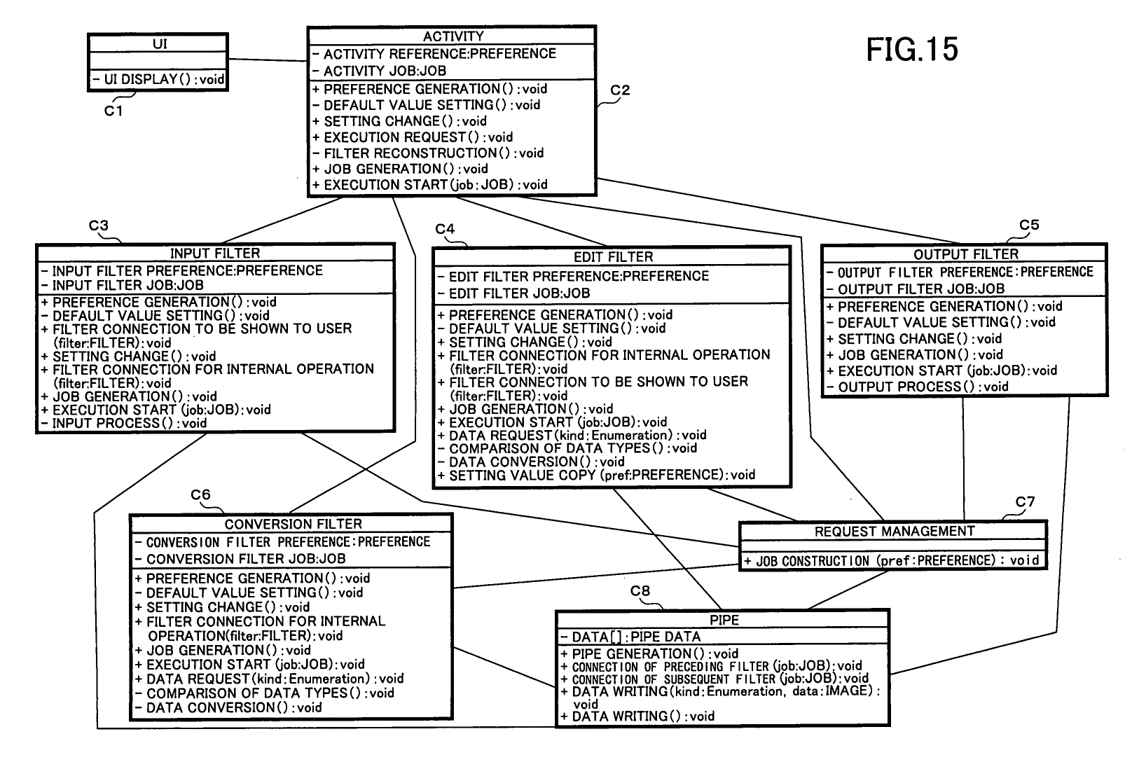

FIG. 15 shows an example of a preference and the like included in each component. The term “preference” herein referred to means information including, for instance, a setting for operation details of each component and connection relationships with other components.

In FIG. 15, the UI C1 includes a member function (method) of “UI display ( )”. The activity C2 includes “activity preference” and “activity job” and member functions of “preference generation ( )”, “default value setting ( )”, “setting change ( )”, “execution request ( )”, “filter reconstruction ( )”, “job generation ( )” and “execution start (job:JOB)”. The input filter C3 includes “input filter preference” and “input filter job” and member functions of “preference generation ( )”, “default value setting ( )”, “filter connection to be shown to user (filter:FILTER)”, “setting change ( )”, “filter connection for internal operation (filter:FILTER)”, “job generation ( )”, “execution start (job:JOB)” and “input process ( )”. The edit filter C4 includes “edit filter preference” and “edit filter job” and member functions of “preference generation ( )”, “default value setting ( )”, “setting change ( )”, “filter connection for internal operation (filter:FILTER)”, “filter connection to be shown to user (filter:FILTER)”, “job generation ( )”, “execution start (job:JOB)”, “data request (kind:Enumeration)”, “comparison of data types ( )”, “data conversion ( )” and “setting value copy (pref:PREFERENCE)”. The output filter C5 includes “output filter preference” and “output filter job” and member functions of “preference generation ( )”, “default value setting ( )”, “setting change ( )”, “job generation ( )”, “execution start (job:JOB)” and “output process ( )”. The conversion filter C6 includes “conversion filter preference” and “conversion filter job” and member functions of “preference generation ( )”, “default value setting ( )”, “setting change ( )”, “filter connection for internal operation (filter:FILTER)”, “job generation ( )”, “execution start (job:JOB)”, “data request (kind:Enumeration)”, “comparison of data types ( )” and “data conversion ( )”. The request management C7 includes a member function of “job construction (pref:PREFERENCE)”. The pipe C8 includes “data [ ]” and member functions of “pipe generation ( )”, “connection of preceding filter (job:JOB)”, “connection of subsequent filter (job:JOB)”, “data writing (kind:Enumeration, data:IMAGE)” and “data writing ( )”.

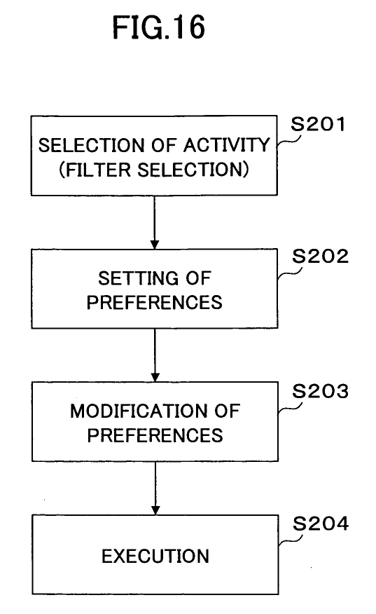

FIG. 16 is a flowchart showing an overview of processing according to the second embodiment. In FIG. 16, first, the user selects the activity C2, and selects filters (the input filter C3, edit filter C4, output filter C5 and the like) for the activity C2 (Step S201). Patterns of the activity C2 selected by the user are various, and such examples are

[1] the input filter C3 is directly connected to the output filter C5;

[2] the input filter C3 is directly connected to two or more output filters C5;

[3] the input filter C3 is connected to the output filter C5 with the edit filter C4 interposed between them;

[4] the input filter C3 is connected to the edit filter C4, which is then connected to two or more output filters C5; and

[5] two or more branches are connected to the input filter C3, and in some of the branches, the edit filter C4 and the output filter C5 are sequentially connected, and in the other branches, the output filter C5 is directly connected. Each pattern is described in greater detail below.

Next, the user configures a setting for operation details of each filter making up the activity C2, and the activity C2 sets a preference for each of its own and lower order filters (Step S202).

Subsequently, when an execution request is received from the user, the activity C2 modifies the preferences to construct an internal filter structure, which is different from a filter structure shown to the user (Step S203). This process is required in order to absorb the difference in types of image data processable by the input filter C3 and by the output filter C5 since the difference cannot be handled by the filter structure of the activity C2 selected by the user.

Finally, the activity C2 is executed (Step S204) to thereby provide a predetermined function to the user.

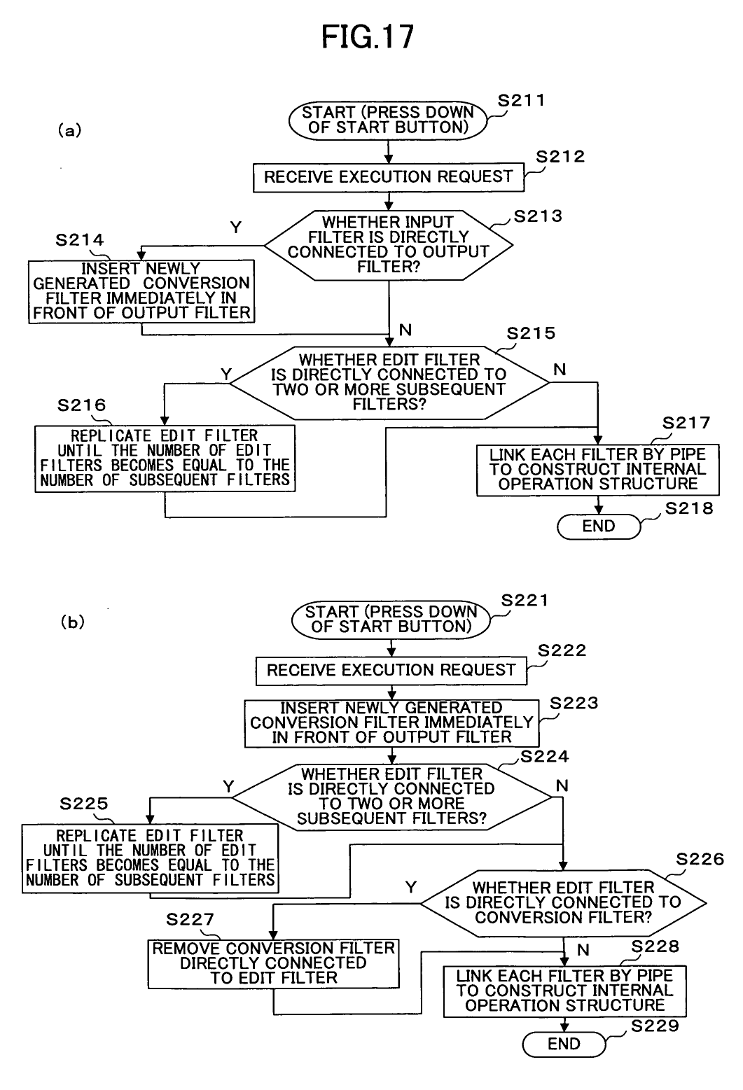

FIG. 17 shows flowcharts illustrating examples of the preference modification process (Step S203 of FIG. 16) by the activity C2, and either a process of FIG. 17(A) or a process of FIG. 17(B) can be adopted.

In FIG. 17(A), when the user presses the start button (Step S211), the activity C2 receives an execution request (Step S212) and determines whether there is an input filter C3 directly connected to an output filter C5 (Step S213).

If it is affirmatively determined (Y at Step S213), the activity C2 newly generates a conversion filter C6 and then inserts the conversion filter C6 immediately in front of the output filter C5 (Step S214). If it is negatively determined (N at Step S213), the activity C2 does not perform the foregoing process. The reason why the newly generated conversion filter 6 is inserted into where the input filter C3 and the output filter C5 are directly connected to each other is to absorb difference in data types since it is sometimes the case that the type of image data processable by the input filter C3 is different from that processable by the output filter C5.

Next, the activity C2 determines whether an edit filter C4 is directly connected to two or more subsequent filters (Step S215). If it is affirmatively determined (Y at Step S215), the activity C2 replicates the edit filter C4 until the number of the edit filters C4 becomes equal to the number of the subsequent filters (Step S216). If it is negatively determined (N at Step S215), the activity C2 does not perform the foregoing process. The reason that replications of an edit filter C4 are generated in the case where the edit filter C4 is directly connected to two or more subsequent filters is because one edit filter C4 is capable of converting data into only a single data type, and therefore it is necessary to provide the edit filters C4 as many as the number of the directly-connected subsequent filters in order to perform data type conversion for each of the subsequent filters.

Then, the activity C2 links each filter by the pipe C8 to construct an internal operation structure that cannot be seen by the user (Step S217), and then ends the processing (Step S218).

In FIG. 17(B), when the user presses the start button (Step S221), the activity C2 receives an execution request (Step S222), newly generates a conversion filter C6 and then inserts the conversion filter C6 immediately in front of the output filter. C5 (Step S223). In this example, conversion filters C6 are first unconditionally inserted immediately in front of all output filters C5 and later unnecessary conversion filters C6 (i.e. conversion filters C6 following edit filters C4) are removed.

Next, the activity C2 determines whether an edit filter C4 is directly connected to two or more subsequent filters (Step S224). If it is affirmatively determined (Y at Step S224), the activity C2 replicates the edit filter C4 until the number of the edit filters C4 becomes equal to the number of the subsequent filters (Step S225). If it is negatively determined (N at Step S224), the activity C2 does not perform the foregoing process.

Subsequently, the activity C2 determines whether an edit filter C4 is directly connected to a conversion filter C6 (Step S226). If it is affirmatively determined (Y at Step S226), the activity C2 removes the conversion filter C6 (Step S227). If it is negatively determined (N at Step S226), the activity C2 does not perform the foregoing process.

Then, the activity C2 links each filter by the pipe C8 to construct an internal operation structure that cannot be seen by the user (Step S228), and then ends the processing (Step S229).

The following description is based on more particular examples.

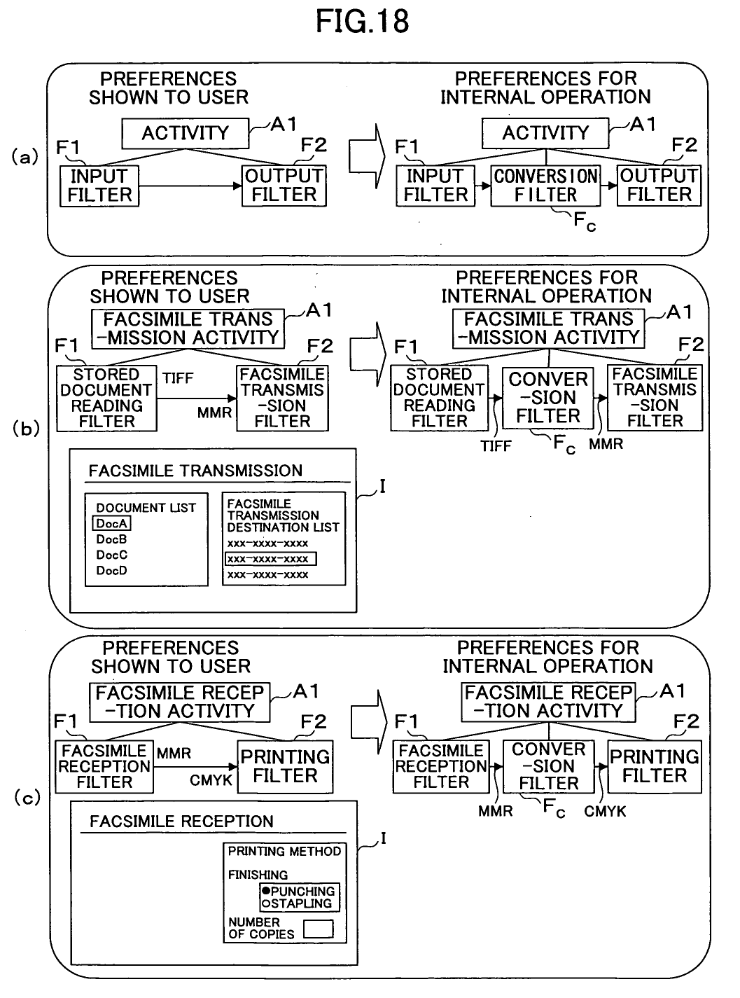

FIG. 18 illustrates the above-mentioned pattern [1] with FIG. 18(A) showing a general form and FIGS. 18(B) and 18(C) showing particular examples.

In FIG. 18(A), preferences shown to the user are an activity Al where an input filter F1 is directly connected to an output filter F2; however, the preferences are modified for the internal operation, and the modified preferences are the activity A1 where a conversion filter F_{c} is inserted between the input filter F1 and the output filter F2.

In FIG. 18(B), the activity A1 is a facsimile transmission activity; the input filter F1, the stored document reading filter; and the output filter F2, the facsimile transmission filter. The user selects, as preferences shown to the user, the facsimile transmission activity A1 wherein the stored document reading filter F1 is directly connected to the facsimile transmission filter F2. Then, on a setting screen I, the user configures operation details (e.g. document selection from a document list) of the stored document reading filter F1 and operation details (e.g. destination selection from a facsimile transmission destination list) of the facsimile transmission filter F2.

In this case, with the preferences shown to the user, the facsimile transmission activity A1 cannot be implemented since output data of the stored document reading filter F1 is in TIFF format and input data of the facsimile transmission filter F2 is in MMR format. However, with the preferences for the internal operation, the facsimile transmission activity A1 is implemented without problems since the conversion filter F_{c} is inserted between the stored document reading filter F1 and the facsimile transmission filter F2, whereby the data is converted from TIFF to MMR.

In FIG. 18(C), the activity A1 is a facsimile reception activity; the input filter F1, the facsimile reception filter; and the output filter F2, the printing filter. The user selects, as preferences shown to the user, the facsimile reception activity A1 where the facsimile reception filter F1 is directly connected to the printing filter F2. Then, on the setting screen I, the user configures operation details (e.g. selection of a finishing operation, and input of the number of copies) of the printing filter F2.

In this case, with the preferences shown to the user, the facsimile reception activity A1 cannot be implemented since output data of the facsimile reception filter F1 is in MMR format and input data of the printing filter F2 is in CMYK format. However, with the preferences for the internal operation, the facsimile reception activity A1 is implemented without problems since the conversion filter F_{c} is inserted between the facsimile reception filter F1 and the printing filter F2, whereby the data is converted from MMR to CMYK.

Also in the case where the activity A1 is a mail transmission activity; the input filter F1, the stored document reading filter (output data in JPEG format); and the output filter F2, the mail transmission filter (input data in JPEG format), the conversion filter F_{c} is inserted between the stored document reading filter F1 and the mail transmission filter F2. However, since the output data of the stored document reading filter F1 and the input data of the mail transmission filter F2 are in the same format, a conversion is not practically performed and the data is passed through to the mail transmission filter F2.

This is also true when the activity A1 is a facsimile reception activity; the input filter F1, the facsimile reception filter (output data in MMR format); and the output filter F2, the facsimile transmission filter (input data in MMR).

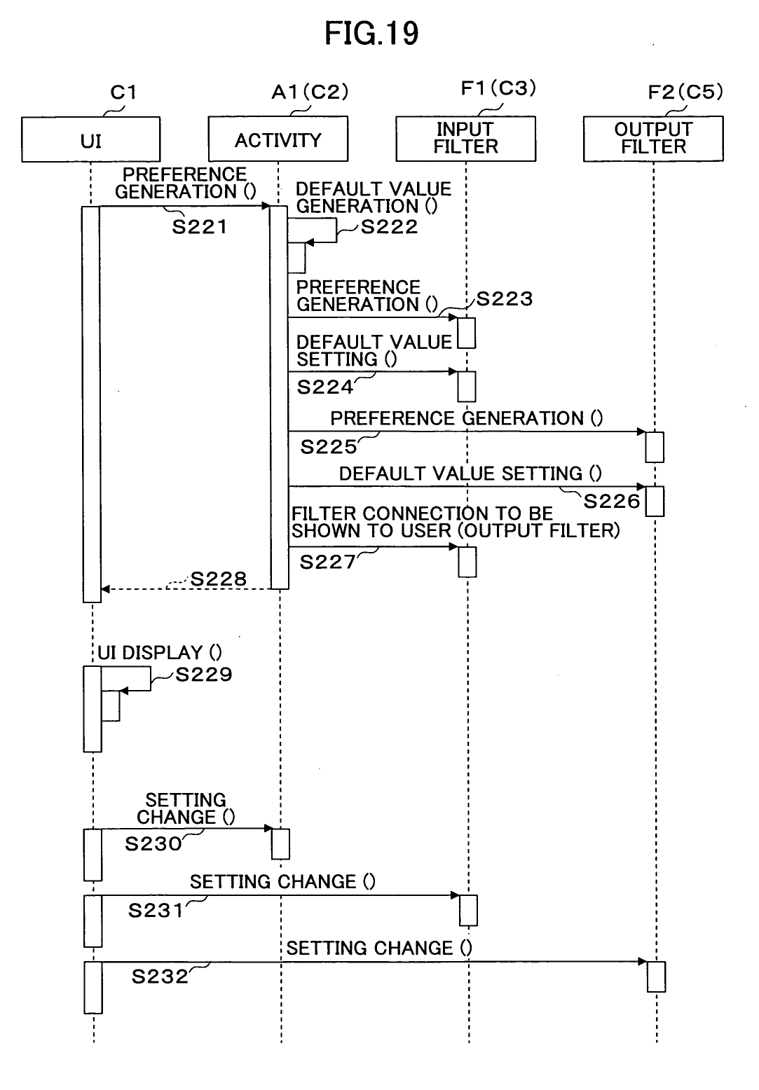

FIG. 19 is a sequence diagram showing an example of the preference configuration process (Step S202 of FIG. 16) according to the above-mentioned pattern [1].

In FIG. 19, in response to selection of an activity by the user, the UI C1 requests the activity A1 (C2) to generate a preference (Step S221). Herewith, the activity A1 (C2) generates default values of its own preference (Step S222), and requests the input filter F1 (C3) to generate its preference (Step S223) and then to set a generated default value (Step S224). In the same manner, the activity A1 (C2) requests the output filter F2 (C5) to generate its preference (Step S225) and then to set a generated default value (Step S226).

Next, the activity A1 (C2) requests the input filter F1 (C3), as specifying the output filter F2 (C5), to make a filter connection with the output filter F2 (C5), which is to be shown to the user (Step S227), and then makes a response to the UI C1 to notify completion of the process (Step S228). The filter connection to be shown to the user is done by setting the preference of the output filter F2 in “subsequent filter to be shown to user” of the preference of the input filter F1, as described below.

Subsequently, the UI C1 displays a UI for allowing the user to configure operation details (Step S229), and requests the activity A1 (C2) for a setting change in accordance with the user operation (Step S230). Then, the UI C1 requests the input filter F1 (C3) for a setting change (Step S231) and also requests the output filter F2 (C5) for a setting change (Step S232).

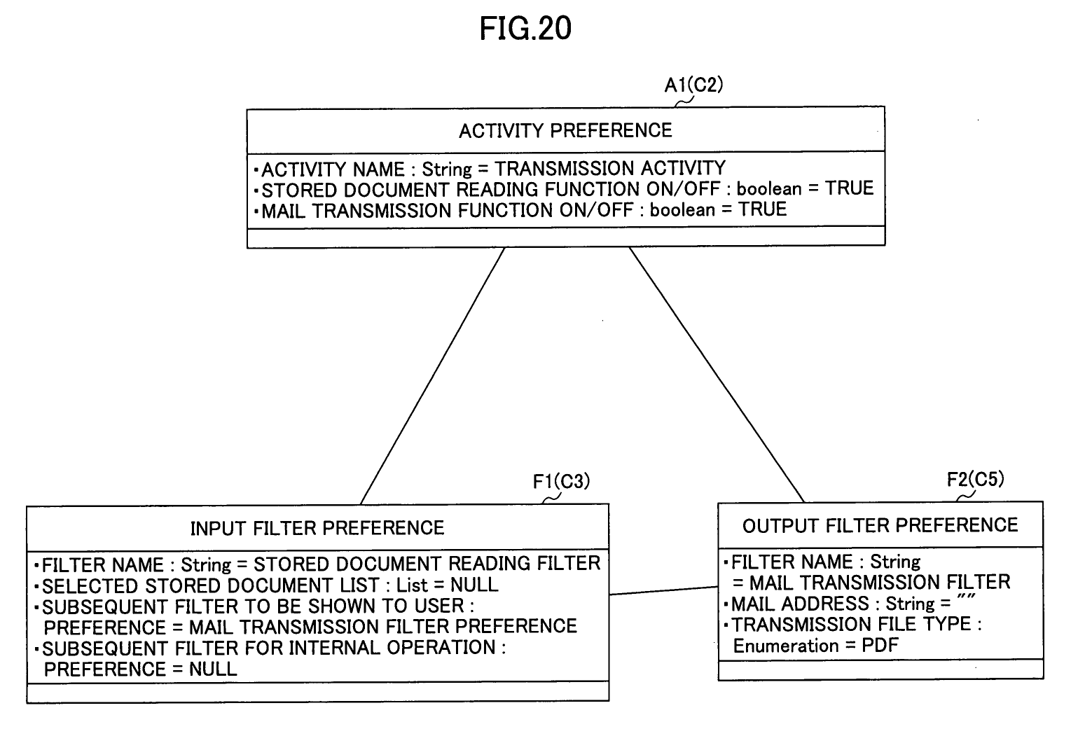

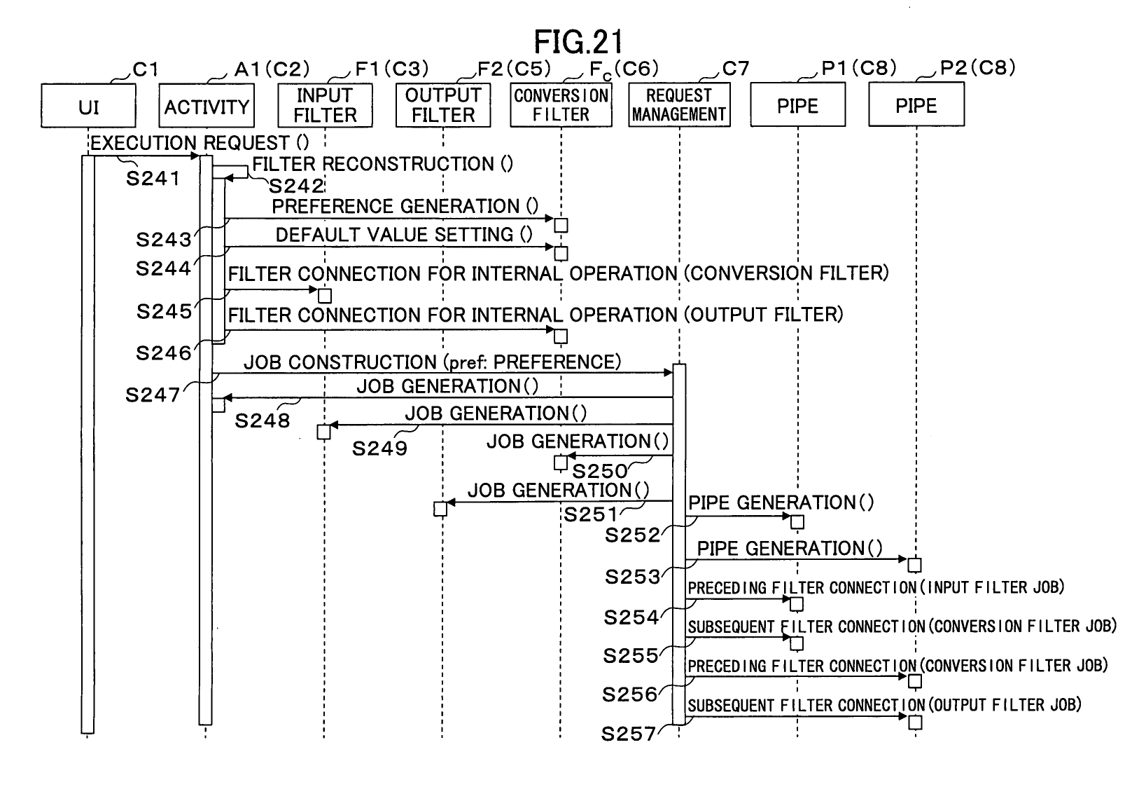

A preference included in each component at this point (i.e. at the completion of Step S232) is illustrated in FIG. 20. That is, in the activity preference of the activity A1 (C2), “transmission activity” is set in “activity name”; “TRUE” in “stored document reading function ON/OFF”; and “TRUE” in “mail transmission function ON/OFF”. In the input filter preference of the input filter F1 (C3), “stored document reading filter” is set in “filter name”; “NULL” in “selected stored document list”; “mail transmission filter preference” in “subsequent filter to be shown to user”; and “NULL” in “subsequent filter for internal operation”. In the output filter preference of the output filter F2 (C5), “mail transmission filter” is set in “filter name”; “″″” in “mail address; and “PDF” in “transmission file type”.

FIG. 21 is a sequence diagram showing an example of the preference modification process (Step S203 of FIG. 16) according to the above-mentioned pattern [1].

In FIG. 21, in response to a press on the start button by the user, the UI C1 sends an execution request to the activity A1 (C2) (Step S241). The activity A1 (C2) starts filter reconstruction (Step S242), and requests the newly generated conversion filter F_{c} (C6) to generate its preference (Step S243) and then requests the conversion filter F_{c} (C6) to set a default value (Step S244).

Next, the activity A1 (C2) requests the input filter F1 (C3), as specifying the conversion filter F_{c} (C6), to make a filter connection with the conversion filter F_{c} (C6) for the internal operation (Step S245), and requests the conversion filter F_{c} (C6), as specifying the output filter F2 (C5), to make a filter connection with the output filter F2 (C5) for the internal operation (Step S246).

Subsequently, the activity A1 (C2) requests the request management C7 for job construction (Step S247), and the request management C7 generates jobs sequentially for the activity A1 (C2), input filter F1 (C3), conversion filter F_{c} (C6) and output filter F2 (C5) (Steps S248 to S251).

Next, the request management C7 generates a pipe P1 (C8) and a pipe P2 (C8) (Steps S252 and S253). The request management C7 then requests the pipe P1 (C8), as specifying the input filter job, to make a preceding filter connection (Step S254) and also, as specifying the conversion filter job, to make a subsequent filter connection (Step S255). Similarly, the request management C7 requests the pipe P2 (C8), as specifying the conversion filter job, to make a preceding filter connection (Step S256) and also, as specifying the output filter job, to make a subsequent filter connection (Step S257).

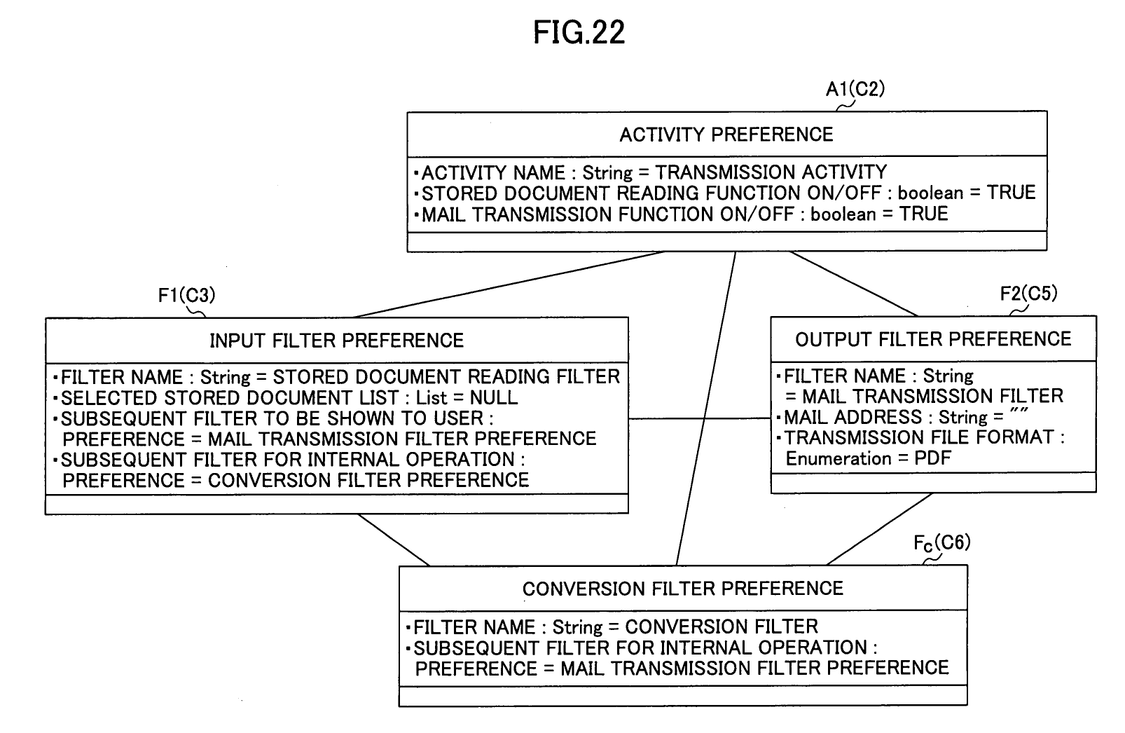

A preference included in each component at this point (i.e. at the completion of Step S257) is illustrated in FIG. 22. That is, although the activity preference of the activity A1 (C2) and the output filter preference of the output filter F2 (C5) are the same in FIG. 20, “subsequent filter for internal operation” in the input filter preference of the input filter F1 (C3) is changed from “NULL” to “conversion filter preference”. In addition, the conversion filter preference of the conversion filter F_{c} (C6) is newly shown in the figure. In the conversion filter preference of the conversion filter F_{c} (C6), “conversion filter” is set in “filter name”; and “mail transmission filter preference” in “subsequent filter for internal operation”.

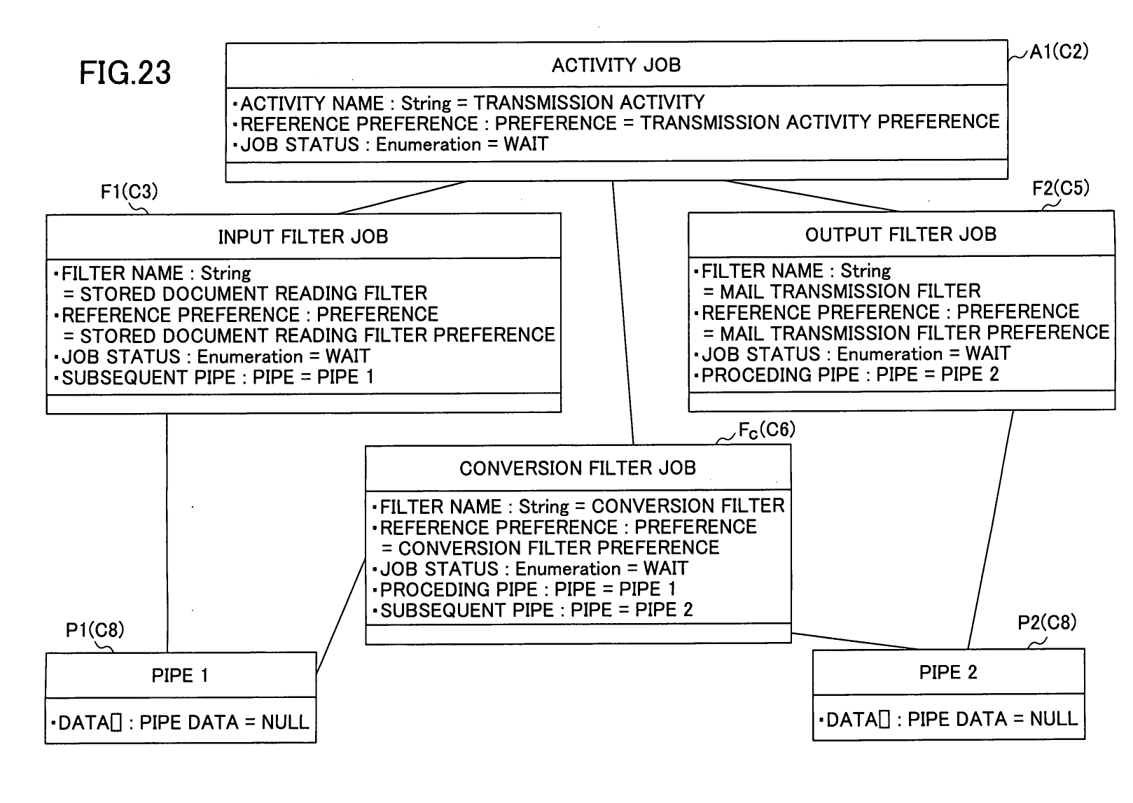

FIG. 23 shows a job of each component that becomes effective due to the job generation. That is, in the activity job of the activity A1 (C2), “transmission activity” is set in “activity name”; “transmission activity preference” in “reference preference”; and “WAIT” in “job status”. In the input filter job of the input filter F1 (C3), “stored document reading filter” is set in “filter name”; “stored document reading filter preference” in “reference preference”; “WAIT” in “job status”; and “pipe 1”, in “subsequent pipe”. In the output filter job of the output filter F2 (C5), “mail transmission filter” is set in “filter name”; “mail transmission filter preference” in “reference preference”; “WAIT” in “job status”; and “pipe 2” in “preceding pipe”. In the conversion filter job of the conversion filter F_{c} (C6), “conversion filter” is set in “filter name”; “conversion filter preference” in “reference preference”; “WAIT” in “job status”; “pipe 1” in “preceding pipe”; and “pipe 2” in “subsequent pipe”. Data of the pipe P1 (CB) and pipe P2 (CB) is set to “NULL”.

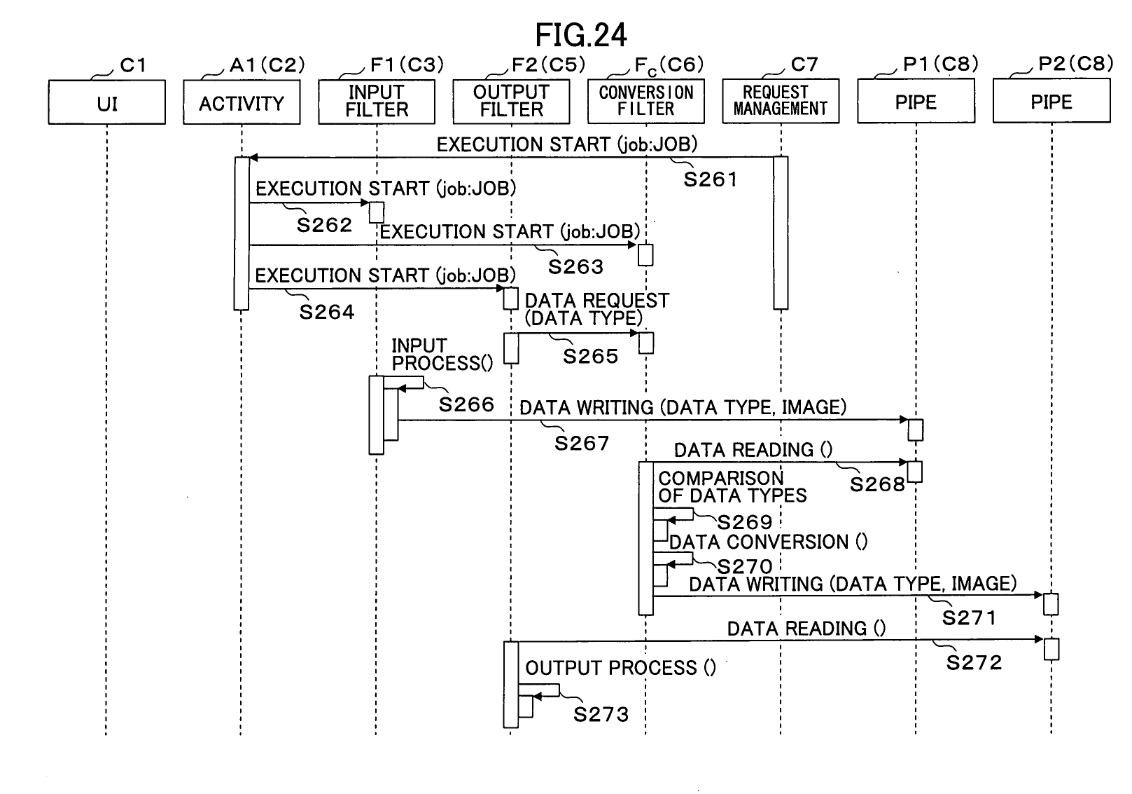

FIG. 24 is a sequence diagram showing an example of the execution process (Step S204 of FIG. 16) according to the above-mentioned pattern [1].

In FIG. 24, the request management C7 requests the activity A1 (C2) to start process execution (Step S261), and the activity A1 (C2) requests the start of process execution sequentially to the input filter F1 (C3), conversion filter F_{c} (C6) and output filter F2 (C5) (Steps S262 to S264).

In response to the request, the input filter F1 (C3) starts the input process (Step S266) and writes data in the pipe P1 (Step S267).

The output filter F2 (C5) requests, as specifying a data type, the conversion filter F_{c} (C6) for data (Step S265). After completion of data writing by the input filter F1 (C3) into the pipe P1 (C8), the conversion filter F_{c} (C6) reads the data from the pipe P1 (CB) (Step S268).

Then, the conversion filter F_{c} (C6) compares the type of the read data and the data type specified by the output filter F2 (C5) (Step S269), and carries out data conversion in the case when the data types are different and the data therefore needs to be converted (Step S270). When the data types are the same and the data therefore needs not to be converted, the conversion filter F_{c} (C6) does not perform data conversion. Subsequently, the conversion filter F_{c} (C6) writes the converted data into the pipe P2 (C8) (Step S271).

The output filter F2 (C5) reads data from the pipe P2 (C8) (Step S272) and performs an output process (Step S273).

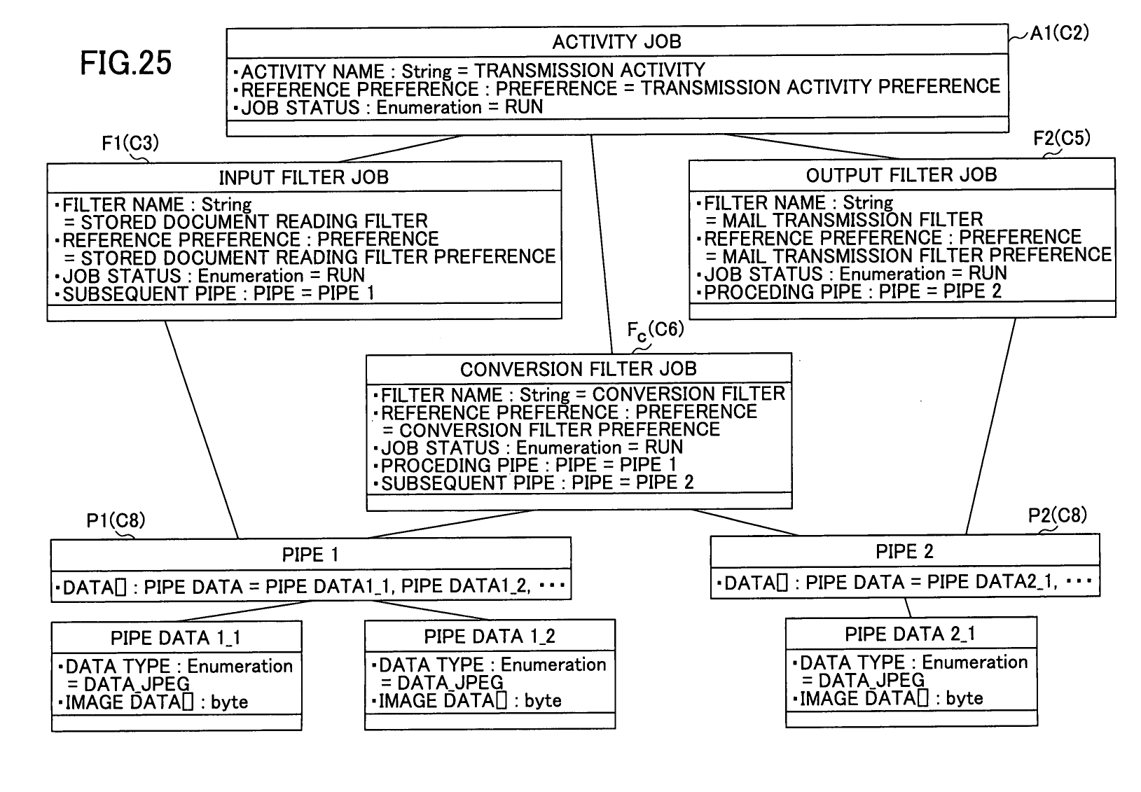

FIG. 25 shows a job and the like of each component in execution. That is, “job status” of the respective activity job, input filter job, output filter job and conversion filter job is changed from “WAIT” to “RUN”, and “pipe data 1_{—}1”, “pipe data 1_{—}2” and . . . are written in the pipe P1 (C8) and “pipe data 2_{—}1” and . . . are written in the pipe P2 (C8). In “pipe data 1_{—}1”, “pipe data 1_{—}2”, “pipe data 2_{—}1” and . . . , “data type=DATA_JPEG” and “image data” are written.

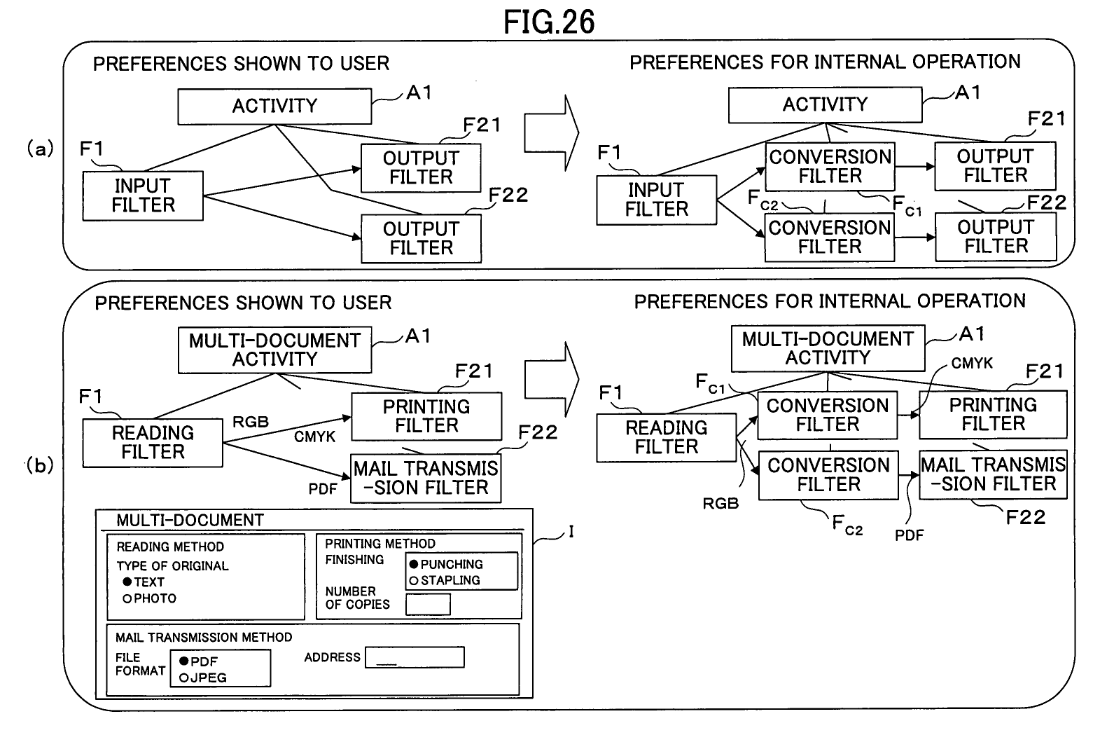

FIG. 26 illustrates the above-mentioned pattern [2] with FIG. 26(A) showing a general form and FIG. 26(B) showing a particular example.

In FIG. 26(A), preferences shown to the user are the activity A1 where the input filter F1 is directly connected to multiple output filters F21 and F22; however, the preferences are modified for the internal operation, and the modified preferences are the activity A1 where conversion filters F_{c1} and F_{c2} are inserted between the input filter F1 and the output filter F21 and between the input filter F1 and the output filter F22, respectively.

In FIG. 26(B), the activity A1 is a multi-document activity; the input filter F1, the reading filter; the output filter F21, the printing filter; and the output filter F22, the mail transmission filter. The user selects, as preferences shown to the user, the multi-document activity A1 where the reading filter F1 is directly connected to the printing filter F21 and to the mail transmission filter F22. Then, on the setting screen I, the user configures operation details (e.g. selection of a type of the original) of the reading filter F1, operation details (e.g. selection of the finishing method and input of the number of copies) of the printing filter F21 and operation details (e.g. selection of the file type and input of an address) of the mail transmission filter F22.

In this case, with the preferences shown to the user, the multi-document activity A1 cannot be implemented since output data of the reading filter F1 is in RGB format, input data of the printing filter F21 is in CMYK format, and input data of the mail transmission filter F22 is in PDF format. However, with the preferences for the internal operation, the multi-document activity A1 is implemented without problems since the conversion filter F_{c1} is inserted between the reading filter F1 and the printing filter F21, whereby the data is converted from RGB to CMYK, and the conversion filter F_{c2} is inserted between the reading filter F1 and the mail transmission filter F22, whereby the data is converted from RGB to PDF.

The preference configuration process (Step S202 of FIG. 16) of the pattern [2] is different from that of FIG. 19 in two output filters F21 and F22, instead of a single output filter (F2), and an added process due to the increase in the number of the output filters; and the filter connection relationships shown to the user.

The basic flow of the preference modification process (Step S203 of FIG. 16) according to the pattern [2] is the same as shown in FIG. 17. A detailed sequence diagram of the pattern [2] is different from one shown in FIG. 21 in two output filters F21 and F22, instead of a single output filter (F2); two conversion filters F_{c1} and F_{c2}, instead of a single conversion filter (F_{c}); two more pipes for filter connection and the processes of the added two pipes; and the filter connection relationships shown to the user.

In addition, the execution process (Step S204 of FIG. 16) according to the pattern [2] is different from that of FIG. 24 in two output filters F21 and F22, instead of a single output filter (F2); two conversion filters F_{c1} and F_{c2}, instead of a single conversion filter (F_{c}); two more pipes for filter connection and the processes of the added two pipes; and the filter connection relationships shown to the user.

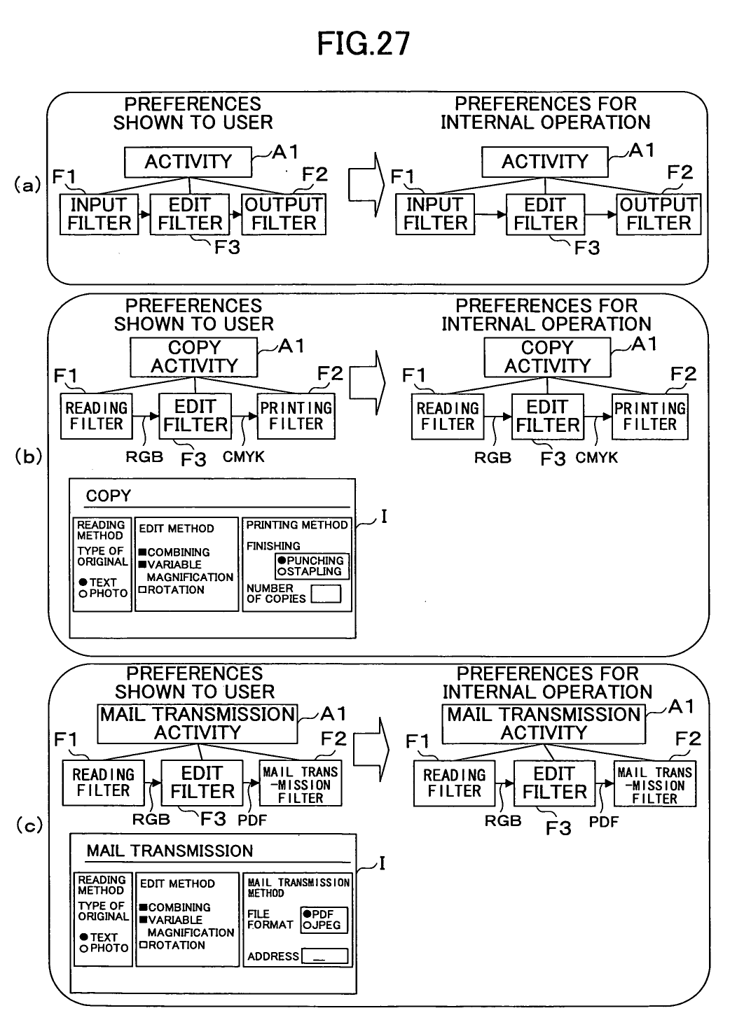

FIG. 27 illustrates the above-mentioned pattern [3] with FIG. 27(A) showing a general form and FIGS. 27(B) and 27(C) showing particular examples.

In FIG. 27(A), preferences shown to the user are the activity A1 where the input filter F1 is connected to the output filter F2 with an edit filter F3 interposed between them. In this pattern, the preference structure is not changed after the preference modification for the internal operation since the edit filter F3 also serves the function of the conversion filter.

In FIG. 27(B), the activity A1 is the copy activity; the input filter F1, the reading filter; and the output filter F2, the printing filter. The user selects, as preferences shown to the user, the copy activity A1 where the reading filter F1 is connected to the printing filter F2 with the edit filter F3 interposed between them. Then, on the setting screen I, the user configures operation details (e.g. selection of a type of the original) of the reading filter F1, operation details (e.g. selection of the edit method) of the edit filter F3, and operation details (e.g. selection of the finishing method and input of the number of copies) of the printing filter F2.

In this case, although output data of the reading filter F1 is in RGB format and input data of the printing filter F2 is in CMYK format, the copy activity A1 is implemented without problems since the edit filter F3 converts the output data from RGB to CMYK.

In FIG. 27(C), the activity A1 is the mail transmission activity; the input filter F1, the reading filter; and the output filter F2, the mail transmission filter. The user selects, as preferences shown to the user, the mail transmission activity A1 where the reading filter F1 is connected to the mail transmission filter F2 with the edit filter F3 interposed between them. Then, on the setting screen I, the user configures operation details (e.g. selection of a type of the original) of the reading filter F1, operation details (e.g. selection of the edit method) of the edit filter F3, and operation details (e.g. selection of the file type and input of an address) of the mail transmission filter F2.

In this case, although output data of the reading filter F1 is in RGB format and input data of the mail transmission filter F2 is in PDF format, the mail transmission activity A1 is implemented without problems since the edit filter F3 converts the output data from RGB to PDF.

The preference configuration process (Step S202 of FIG. 16) of the pattern [3] is different from that of FIG. 19 in the added edit filter F3 and the process of the added edit filter F3; and the filter connection relationships shown to the user.

The basic flow of the preference modification process (Step S203 of FIG. 16) according to the pattern [3] is the same as shown in FIG. 17. A detailed sequence diagram of the pattern [3] is the same as FIG. 21, except for the conversion filter F_{c} being replaced with the edit filter F3. Note however that the edit filter F3 already exists and there is therefore no need to newly generate it.

In addition, the execution process (Step S204 of FIG. 16) according to the pattern [3] is the same as FIG. 24, except for the conversion filter F_{c} being replaced with the edit filter F3. Note however that the edit filter F3 performs its original editing process in addition to the conversion process.

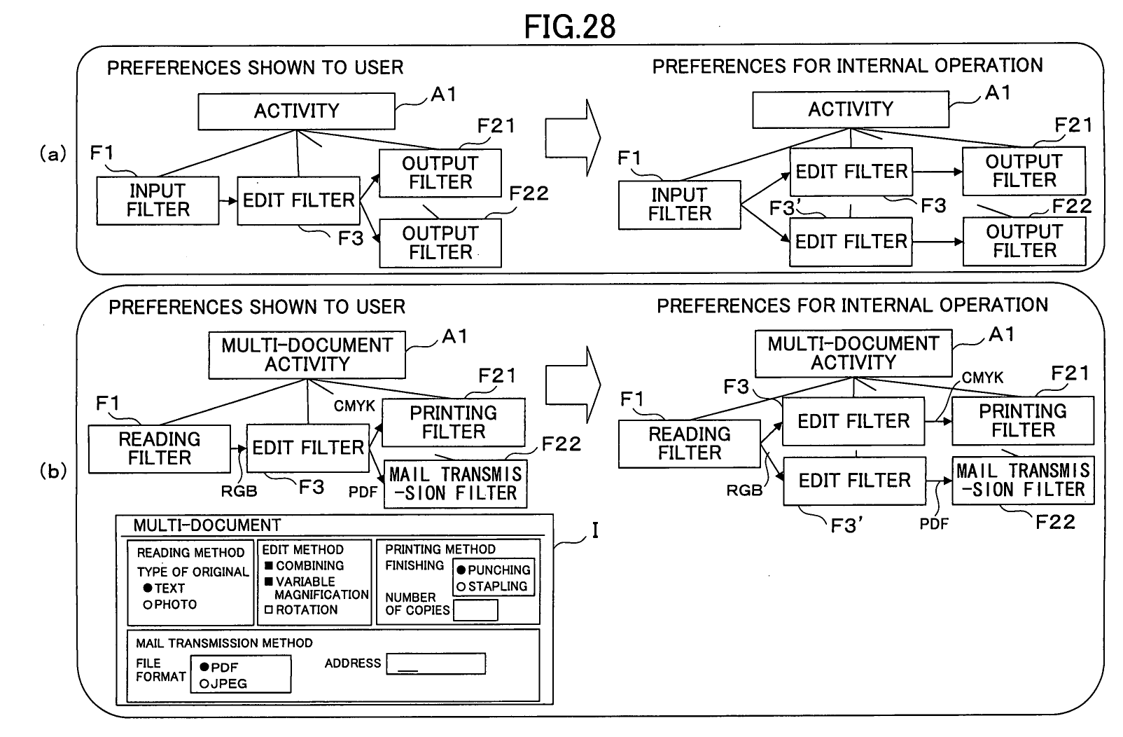

FIG. 28 illustrates the above-mentioned pattern [4] with FIG. 28(A) showing a general form and FIG. 28(B) showing a particular example.

In FIG. 28(A), preferences shown to the user are the activity A1 where the input filter F1 is connected to the edit filter F3 to which multiple output filters F21 and F22 are directly connected; however, the preferences are modified for the internal operation, and the modified preferences are the activity A1 where the input filter F1 is connected to multiple edit filters F3 and F3′, to which the output filters F21 and F22, respectively, are connected. The edit filter F3′ is added by replicating the edit filter F3.

In FIG. 28(B), the activity A1 is the multi-document activity; the input filter F1, the reading filter; the output filter F21, the printing filter; and the output filter F22, the mail transmission filter. The user selects, as preferences shown to the user, the multi-document activity A1 where the reading filter F1 is connected to the edit filter F3, to which the printing filter F21 and the mail transmission filter F22 are directly connected. Then, on the setting screen I, the user configures operation details (e.g. selection of a type of the original) of the reading filter F1, operation details (e.g. selection of the editing method) of the edit filter F3, operation details (e.g. selection of the finishing method and input of the number of copies) of the printing filter F21 and operation details (e.g. selection of the file type and input of an address) of the mail transmission filter F22.

In this case, with the preferences shown to the user, the multi-document activity A1 cannot be implemented since output data of the reading filter F1 is in RGB format, input data of the printing filter F21 is in CMYK format and input data of the mail transmission filter F22 is in PDF format, and one edit filter F3 cannot output data in two different formats at the same time. However, with the preferences for the internal operation, the multi-document activity A1 is implemented without problems since the read filter F1 is directly connected to the subsequent edit filters F3 and F3′, whereby the edit filter F3 converts the data from RGB to CMYK and the edit filter F3′ converts the data from RGB to PDF.

The preference configuration process (Step S202 of FIG. 16) of the pattern [4] is different from that of FIG. 19 in the added edit filter F3; two output filters F21 and F22, instead of a single output filter (F2), and an added process due to the increase in the number of the output filters; and the filter connection relationships shown to the user.

The basic flow of the preference modification process (Step S203 of FIG. 16) according to the pattern [2] is the same as shown in FIG. 17. A detailed sequence diagram of the pattern [4] is different from one shown in FIG. 21 in two output filters F21 and F22, instead of a single output filter (F2); two edit filters F3 and F3′, instead of a single conversion filter (F_{c}); two more pipes for filter connection and the processes of the added two pipes; and the filter connection relationships shown to the user. Note that the edit filters F3 and F3′ already exist and there is therefore no need to newly generate them.

In addition, the execution process (Step S204 of FIG. 16) according to the pattern [4] is different from that of FIG. 24 in two output filters F21 and F22, instead of a single output filter (F2); two edit filters F3 and F3′, instead of a single conversion filter (F_{c}); two more pipes for filter connection and the processes of the added two pipes; and the filter connection relationships shown to the user.

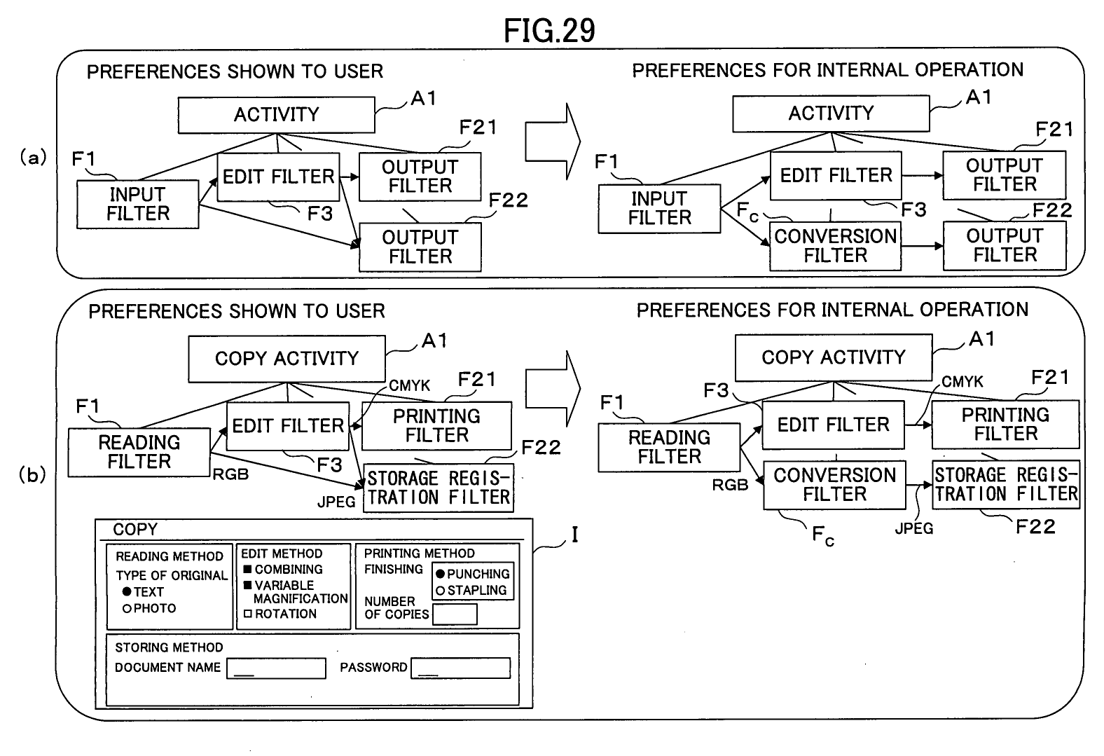

FIG. 29 illustrates the above-mentioned pattern [5] with FIG. 29(A) showing a general form and FIG. 29(B) showing a particular example.

In FIG. 29(A), preferences shown to the user are the activity A1 where the input filter F1 is connected to two branches, in one of which the edit filter F3 and the output filter F21 are sequentially connected, and in the other of which the output filter F22 is directly connected; however, the preferences are modified for the internal operation, and the modified preferences are the activity A1 where the edit filter F3 and the conversion filter F_{c} are separately connected to the input filter F1, the edit filter F3 is connected to the output filter F21, and the conversion filter F_{c} is connected to the output filter F22.

In FIG. 29(B), the activity A1 is the copy activity; the input filter F1, the reading filter; the output filter F21, the printing filter; and the output filter F22, a storage registration filter. The user selects, as preferences shown to the user, the copy activity A1 where each of the edit filter F3 and the storage registration filter F22 is directly connected to the reading filter F1, and the edit filter F3 is connected to the printing filter F21. Then, on the setting screen I, the user configures operation details (e.g. selection of a type of the original) of the reading filter F1, operation details (e.g. selection of the edit method) of the edit filter F3, operation details (e.g. selection of the finishing method and input of the number of copies) of the printing filter F21, and operation details (e.g. document name and input of password) of the storage registration filter F22.

In this case, with the preferences shown to the user, the copy activity A1 cannot be implemented. This is because output data of the reading filter F1 is in RGB format, input data of the printing filter F21 is in CMYK format, and input data of the storage registration filter F22 is in JPEG format, and therefore, although the edit filter F3 converts the data into CMYK format suitable for the printing filter F21, the data formats are different between the reading filter F1 and the storage registration filter F22. However, with the preferences for the internal operation, the copy activity A1 is implemented without problems since the conversion filter F_{c} is inserted in front of the storage registration filter F22, whereby the data is converted from RGB to JPEG.

The preference configuration process (Step S202 of FIG. 16) of the pattern [5] is different from that of FIG. 19 in the added edit filter F3; two output filters F21 and F22, instead of a single output filter (F2), and an added process due to the increase in the number of the output filters; and the filter connection relationships shown to the user.

The basic flow of the preference modification process (Step S203 of FIG. 16) according to the pattern [5] is the same as shown in FIG. 17. A detailed sequence diagram of the pattern [5] is different from one shown in FIG. 21 in two output filters F21 and F22, instead of a single output filter (F2); the added edit filter F3; two more pipes for filter connection and the processes of the added two pipes; and the filter connection relationships shown to the user. Note that the edit filter F3 already exists and there is therefore no need to newly generate it.

In addition, the execution process (Step S204 of FIG. 16) according to the pattern [5] is different from that of FIG. 24 in two output filters F21 and F22, instead of a single output filter (F2); the added edit filter F3; two more pipes for filter connection and the processes of the added two pipes; and the filter connection relationships shown to the user. Note that the edit filter F3 already exists and there is therefore no need to newly generate it.

### CONCLUSION

Thus, the present invention has been described herein with reference to preferred embodiments thereof. The embodiments of the present invention provide an image processing apparatus and an application execution method that simplify functionality customization, functionality extension, or the like. The embodiments of the present invention also provide an image processing apparatus and an application execution method that, in the case where the type of image data processable by an image-data input component is different from that processable by an image-data output component, perform appropriate processing without making the user aware of the difference in the image data types.

While the present invention has been shown and described with particular examples, it should be understood that various changes and modification may be made to the particular examples without departing from the scope of the broad spirit and scope of the present invention as defined in the claims. That is, the scope of the present invention is not limited to the particular examples and the attached drawings.

This application is based on Japanese Patent Application No. 2007-282453 filed in the Japan Patent Office on Oct. 30, 2007, the contents of which are hereby incorporated herein by reference.

What is claimed is:

1. An image processing apparatus comprising:
one or more input units each configured to input data subject to image processing;
one or more output units each configured to output a result of the image processing;
a first filter configured to control input from a corresponding one of the input units in a manner according to the corresponding input unit; and
a second filter configured to control output to a corresponding one of the output units in a manner according to the corresponding output unit,
wherein an application is constructed by connecting the first and the second filters, and
the image processing apparatus further comprising:
a third filter disposed between the first and the second filters and configured to convert an image data type,
wherein during job execution, the third filter makes an inquiry about image data types processable by the first and the second filters, and performs, when the image data types are different from each other, conversion from the image data type processable by the first filter into the image data type processable by the second filter.

2. The image processing apparatus as claimed in claim 1, wherein the conversion performed by the third filter is conducted without intervention from a user.

3. The image processing apparatus as claimed in claim 1, wherein the third filter further performs the image processing based on editing configuration specified by a user.

4. The image processing apparatus as claimed in claim 2, wherein the third filter further performs the image processing based on editing configuration specified by the user.

5. The image processing apparatus as claimed in claim 1, wherein the conversion performed by the third filter is color space conversion.

6. The image processing apparatus as claimed in claim 2, wherein the conversion performed by the third filter is color space conversion.

7. The image processing apparatus as claimed in claim 3, wherein the conversion performed by the third filter is color space conversion.

8. The image processing apparatus as claimed in claim 1, wherein the conversion performed by the third filter is file format conversion.

9. The image processing apparatus as claimed in claim 2, wherein the conversion performed by the third filter is file format conversion.

10. The image processing apparatus as claimed in claim 3, wherein the conversion performed by the third filter is file format conversion.

11. The image processing apparatus as claimed in claim 1, wherein the first filter is one of a reading filter configured to acquire image data generated by a scanner from an original, a stored document reading filter configured to acquire a stored document and a reception filter configured to acquire externally received data.

12. The image processing apparatus as claimed in claim 2, wherein the first filter is one of a reading filter configured to acquire image data generated by a scanner from an original, a stored document reading filter configured to acquire a stored document and a reception filter configured to acquire externally received data.

13. The image processing apparatus as claimed in claim 3, wherein the first filter is one of a reading filter configured to acquire image data generated by a scanner from an original, a stored document reading filter configured to acquire a stored document and a reception filter configured to acquire externally received data.

14. The image processing apparatus as claimed in claim 4, wherein the first filter is one of a reading filter configured to acquire image data generated by a scanner from an original, a stored document reading filter configured to acquire a stored document and a reception filter configured to acquire externally received data.

15. The image processing apparatus as claimed in claim 5, wherein the first filter is one of a reading filter configured to acquire image data generated by a scanner from an original, a stored document reading filter configured to acquire a stored document and a reception filter configured to acquire externally received data.

16. The image processing apparatus as claimed in claim 1, wherein the second filter is one of a printing filter configured to cause image data to be printed on a sheet and the printed sheet to be output, a transmission filter configured to cause image data to be transmitted externally as an image file and a storage registration filter configured to cause a document to be stored in a nonvolatile storage area.

17. The image processing apparatus as claimed in claim 2, wherein the second filter is one of a printing filter configured to cause image data to be printed on a sheet and the printed sheet to be output, a transmission filter configured to cause image data to be transmitted externally as an image file and a storage registration filter configured to cause a document to be stored in a nonvolatile storage area.

18. The image processing apparatus as claimed in claim 3, wherein the second filter is one of a printing filter configured to cause image data to be printed on a sheet and the printed sheet to be output, a transmission filter configured to cause image data to be transmitted externally as an image file and a storage registration filter configured to cause a document to be stored in a nonvolatile storage area.

19. The image processing apparatus as claimed in claim 4, wherein the second filter is one of a printing filter configured to cause image data to be printed on a sheet and the printed sheet to be output, a transmission filter configured to cause image data to be transmitted externally as an image file and a storage registration filter configured to cause a document to be stored in a nonvolatile storage area.

20. An application execution method used in an image processing apparatus including one or more input units each configured to input data subject to image processing; one or more output units each configured to output a result of the image processing; a first filter configured to control input from a corresponding one of the input units in a manner according to the corresponding input unit; and a second filter configured to control output to a corresponding one of the output units in a manner according to the corresponding output unit, wherein an application is constructed by connecting the first and the second filters, the application execution method comprising the steps of:
inserting a third filter between the first and the second filters, the third filter being configured to convert an image data type; and
during job execution, causing the third filter to make an inquiry about image data types processable by the first and the second filters, and perform, when the image data types are different from each other, conversion from the image data type processable by the first filter into the image data type processable by the second filter.
